(19) United States
(12) Patent Application Publication
(10) Pub. No.: US 2025/0166202 A1
(43) Pub. Date: May 22, 2025

(54) DEEP LEARNING FOR NEW AND ENLARGING LESIONS

(71) Applicant: Genentech, Inc., South San Francisco, CA (US)

(72) Inventors: Anitha Priya KRISHNAN, Belmont, CA (US); Zhuang SONG, South San Francisco, CA (US); Richard Alan Duray CARANO, San Ramon, CA (US)

(21) Appl. No.: 19/029,418

(22) Filed: Jan. 17, 2025

Related U.S. Application Data
(63) Continuation of application No. PCT/US2023/070529, filed on Jul. 19, 2023.
(60) Provisional application No. 63/390,527, filed on Jul. 19, 2022.

(51) Int. Cl. G06T 7/00

(52) U.S. Cl. CPC G06T 7/0016; G06T 2207/10088; G06T 2207/20081; G06T 2207/20084; G06T 2207/30016; G06T 2207/30096

(57) ABSTRACT

A method may include training a machine learning model to identify new lesions and/or enlarging lesions that developed within a multitemporal image input between a first timepoint and a second timepoint. The multitemporal image input includes a first image acquired at the first timepoint and a second image acquired at the second timepoint. The machine learning model is trained by at least generating a first representation of the multitemporal image input from the first timepoint to the second timepoint, a second representation of the multitemporal image input from the second timepoint to the first timepoint, a third representation of the multitemporal image input, and a lesion mask identifying the one or more new lesions and/or enlarging lesions. The method also includes applying the trained machine learning model to generate a lesion mask for a patient. Related methods and articles of manufacture are also disclosed.

### CROSS REFERENCE TO RELATED APPLICATION

This application claims priority to U.S. Provisional Application No. 63/390,527, entitled “DEEP LEARNING FOR NEW AND ENLARGING T2 LESIONS” and filed on Jul. 19, 2023, the disclosure of which is incorporated herein by reference in its entirety.

### TECHNICAL FIELD

The present disclosure generally relates to machine learning and more specifically to deep learning based techniques for detecting new and enlarging lesions.

### INTRODUCTION

Magnetic resonance imaging (MRI) is a type of imaging modality that exploits the magnetization properties of atomic nuclei. Most commonly used in neurology and neurosurgery, magnetic resonance imaging (MRI) scans are capable of capturing exquisite details of the brain, spinal cord, and vascular anatomy (including blood flow) in the axial, sagittal, and coronal planes. For example, in some cases, the randomly oriented protons in the water nuclei that are present in a tissue sample may align (or become magnetized) when subjected to a uniform, external magnetic field. A subsequent application of external radio frequency (RF) energy may perturb this alignment (or magnetization) of the water nuclei. As the water nuclei undergo various relaxation processes to return to a resting alignment, the water nuclei present in the tissue sample may emit radio frequency (RF) energy (e.g., echo signals). The radio frequency (RF) energy emitted by the water nuclei returning to their resting alignment may be measured and converted (e.g., through Fourier transformation) to generate a magnetic resonance imaging (MRI) scan. In some cases, a magnetic resonance imaging (MRI) scan may be a three-dimensional volume constructed from a series of successive two-dimensional slices.

Different types of magnetic resonant imaging (MRI) scans may be created by varying the sequence in which pulses of radio frequency (RF) energy are applied to the tissue sample including, for example, the repetition time (TR) (e.g., quantity of time between successive radio frequency (RF) energy pulses) and the time to echo (TE) (e.g., the quantity of time between the delivery of a radio frequency (RF) pulse and the collection of the corresponding echo signal). For example, the term longitudinal relaxation time (or T₁) refers to the time constant determining the rate at which excited protons (in the water nuclei) return to equilibrium. Accordingly, in some cases, a T₁-weighted scan is one type of magnetic resonance imaging (MRI) scan produced by applying a first magnetic resonance imaging (MRI) sequence having a shorter repetition time (TR) and time to echo (TE). Meanwhile, the term transverse relaxation time (or T₂) refers to the time constant that determines the rate at which excited protons (in the water nuclei) reach equilibrium or go out of phase with one another. Thus, a T₂-weighted scan is a different type of magnetic resonance imaging (MRI) scan produced by applying a second magnetic resonance imaging (MRI) sequence having a longer repetition time (TR) and time to echo (TE) (e.g., than the first magnetic resonance imaging (MRI) sequence of T₁-weighted scans). A fluid attenuated inversion recovery (FLAIR) scan is a third type of magnetic resonance imaging (MRI) scan produced by applying a magnetic resonance imaging (MRI) sequence having an even longer repetition time (TR) and time to echo (TE) (e.g., than the second magnetic resonance imaging (MRI) sequence of T₂-weighted scans).

### SUMMARY

Methods, systems, and articles of manufacture, including computer program products, are provided for deep learning based techniques for detecting new and enlarging lesions. In one aspect, there is provided a system. The system may include at least one processor and at least one memory. The at least one memory may store instructions that result in operations when executed by the at least one processor. The operations may include: training a first machine learning model to identify one or more new lesions and/or enlarging lesions that developed within a multitemporal image input between a first timepoint and a second timepoint. The multitemporal image input may include a first image acquired at the first timepoint and a second image acquired at the second timepoint. The first machine learning model may be trained to identify the one or more new lesions and/or enlarging lesions. The training may include generating a first representation of the multitemporal image input from the first timepoint to the second timepoint. The training may also include generating a second representation of the multitemporal image input from the second timepoint to the first timepoint. The training may also include generating a third representation of the multitemporal image input including a concatenation of the first representation and the second representation. The training may also include generating a lesion mask identifying the one or more new lesions and/or enlarging lesions. The lesion mask may correspond to a decoding of the third representation of the multitemporal image input. The operations may also include applying the trained machine learning model to generate, for one or more images of a patient, a patient lesion mask identifying at least one of a new lesion and an enlarging lesion present in the one or more images.

In another aspect, there is provided a deep learning based method for detecting new and enlarging lesions. The method may include: training a first machine learning model to identify one or more new lesions and/or enlarging lesions that developed within a multitemporal image input between a first timepoint and a second timepoint. The multitemporal image input may include a first image acquired at the first timepoint and a second image acquired at the second timepoint. The first machine learning model may be trained to identify the one or more new lesions and/or enlarging lesions. The training may include generating a first representation of the multitemporal image input from the first timepoint to the second timepoint. The training may also include generating a second representation of the multitemporal image input from the second timepoint to the first timepoint. The training may also include generating a third representation of the multitemporal image input including a concatenation of the first representation and the second representation. The training may also include generating a lesion mask identifying the one or more new lesions and/or enlarging lesions. The lesion mask may correspond to a decoding of the third representation of the multitemporal image input. The method may also include applying the trained machine learning model to generate, for one or more images of a patient, a patient lesion mask identifying at least one of a new lesion and an enlarging lesion present in the one or more images.

In another aspect, there is provided a computer program product that includes a non-transitory computer readable storage medium. The non-transitory computer-readable storage medium may include program code that causes operations when executed by at least one processor. The operations may include: training a first machine learning model to identify one or more new lesions and/or enlarging lesions that developed within a multitemporal image input between a first timepoint and a second timepoint. The multitemporal image input may include a first image acquired at the first timepoint and a second image acquired at the second timepoint. The first machine learning model may be trained to identify the one or more new lesions and/or enlarging lesions. The training may include generating a first representation of the multitemporal image input from the first timepoint to the second timepoint. The training may also include generating a second representation of the multitemporal image input from the second timepoint to the first timepoint. The training may also include generating a third representation of the multitemporal image input including a concatenation of the first representation and the second representation. The training may also include generating a lesion mask identifying the one or more new lesions and/or enlarging lesions. The lesion mask may correspond to a decoding of the third representation of the multitemporal image input. The operations may also include applying the trained machine learning model to generate, for one or more images of a patient, a patient lesion mask identifying at least one of a new lesion and an enlarging lesion present in the one or more images.

In some variations, one or more of the features disclosed herein including the following features can optionally be included in any feasible combination. In some variations, encoding blocks of the first machine learning model include a first unidirectional convolutional gated recurrent unit (cGRU) configured to generate the first representation of the multitemporal image input and a second unidirectional convolutional gated recurrent unit configured to generate the second representation of the multitemporal image input.

In some variations, the first machine learning model includes one or more convolutional layers configured to decode the third representation of the multitemporal image input.

In some variations, the generating the first representation of the multitemporal image input includes extracting a first set of temporal features present in the multitemporal image input from the first timepoint to the second timepoint. The generating the second representation of the multitemporal image input may include extracting a second set of temporal features present in the multitemporal image input from the second timepoint to the first timepoint.

In some variations, the multitemporal image input includes a 6-dimensional tensor including a batch size, a timepoint, channels, and spatial coordinates for the encoder.

In some variations, the third representation of the multitemporal image input includes a 5-dimensional tensor including a batch size, channels, and spatial coordinates for the decoder.

In some variations, the multitemporal image input includes a reference lesion mask identifying one or more existing lesions present in the first image and/or the second image. The reference lesion mask may be configured to provide attention to the one or more existing lesions.

In some variations, the reference lesion mask is generated by applying a second machine learning model.

In some variations, the second machine learning model is pre-trained based on a cross-sectional magnetic resonance imaging sequence and an annotation of the cross-sectional magnetic resonance imaging sequence.

In some variations, the first machine learning model and the second machine learning model are chained such that an output of the second machine learning model is provided as an input to the first machine learning model.

In some variations, the first machine learning model and the second machine learning model are jointly trained including by backpropagating a loss associated with incorrectly identifying the one or more new lesions and/or enlarging lesions through the first machine learning model and the second machine learning model and a loss associated with incorrectly identifying lesions at the first timepoint and the second timepoints through the second machine learning model.

In some variations, the first image and the second image include T₂-weighted images or fluid attenuated inversion recovery images.

In some variations, the first machine leaning model is trained based one or more lesion masks with ground truth annotations.

In some variations, each of the first representation and the second representation is an encoding of the multitemporal image input.

In some variations, post processing may be performed to determine if a new lesion and/or an enlarging lesion identified in the patient lesion mask is a false positive. The patient lesion mask may be rejected for one or more downstream clinical tasks in response to determining that the new lesion and/or the enlarging lesion identified in the patient lesion mask is a false positive.

In some variations, the new lesion and/or the enlarging lesion may be determined to be a false positive based at least on a first intensity value of one or more constituent voxels in a first patient image from the first timepoint, a second intensity value of one or more constituent voxels in a second patient image from the second timepoint, and a third intensity value of one or more background voxels in the first patient image and/or the second patient image.

In some variations, the new lesion may be determined to be a false positive based at least on one or more voxels identified by the patient lesion mask as corresponding to the new lesion being (i) identified as corresponding to an existing lesion in a first reference lesion mask of the patient from a first timepoint, or (ii) identified as background voxels in a second reference lesion mask of the patient from a second timepoint.

In some variations, the enlarging lesion may be determined to be a false positive based at least on (i) one or more voxels identified by the patient lesion mask as corresponding to the enlarging lesion being absent in a first reference lesion mask of the patient from a first timepoint or a second reference lesion mask of the patient from a second timepoint, and (ii) the one or more voxels being a part of an existing lesion whose change in dimensions between the first timepoint and the second timepoint fails to satisfy one or more thresholds.

In some variations, a threshold quantity of patient lesions masks generated by the trained machine learning model based on patient images may be determined to include a false positive identification of a new lesion or an enlarging lesion. The trained machine learning model may be retrained upon determining that the threshold quantity of patient lesion mask generated by the trained machine learning model includes a false positive identification of a new lesion or an enlarging lesion.

In some variations, each voxel in the patient lesion mask may be labeled a first value to indicate the voxel as being a part of a new lesion, a second value to indicate the voxel as being a part of an enlarging lesion, or a third value to indicate the voxel as being a background voxel.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to deep learning techniques for identifying new and/or enlarging T₂ lesions, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example lesion segmentation system, consistent with implementations of the current subject matter;

FIG. 2 depicts a network diagram illustrating a lesion segmentation system, consistent with implementations of the current subject matter;

FIG. 3 depicts another network diagram illustrating a lesion segmentation system, consistent with implementations of the current subject matter;

FIG. 4A depicts a flowchart illustrating an example of a process for deep learning based detection of new and enlarging lesions, consistent with implementations of the current subject matter;

FIG. 4B depicts a flowchart illustrating another example of a process for deep learning based detection of new and enlarging lesions, consistent with implementations of the current subject matter;

FIG. 4C depicts a flowchart illustrating another example of a process for deep learning based detection of new and enlarging lesions, consistent with implementations of the current subject matter;

FIG. 5 depicts a performance comparison of machine learning models and approaches;

FIG. 6 depicts a performance comparison of machine learning models and approaches;

FIG. 7 depicts example magnetic resonance imaging images showing new and enlarging T₂ lesions;

FIG. 8 depicts a performance comparison of machine learning models and approaches; and

FIG. 9 depicts a block diagram illustrating an example of a computing system, consistent with implementations of the current subject matter.

When practical, like labels are used to refer to same or similar items in the drawings.

### DETAILED DESCRIPTION

Magnetic resonance imaging (MRI), which is capable of capturing highly detailed scans of the brain, the spinal cord, and the constituent vasculature, may play a key role in the diagnosis, the assessment of disease activity, and the evaluation of treatment response in a variety of neurological disorders such as multiple sclerosis. Multiple sclerosis is a chronic autoimmune disease of the central nervous system leading to demyelination and atrophy of various brain and spinal cord structures. Lesions that appear in scans produced by different magnetic resonance imaging (MRI) sequences may represent different aspects of the disease process. For example, T₁ lesions, which are lesions that appear in T₁-weighted scans, may indicate acute inflammatory activity and chronic neuronal loss. Contrastingly, T₂ lesions, which appear in T₂-weighted scans, are relatively nonspecific and tend to be larger and occur more frequently compared to T₁ lesions. While T₁ gadolinium contrast enhancing lesions and new and enlarging T₂ lesions can both serve as biomarkers for disease activity or progression in multiple sclerosis, T₁ gadolinium contrast enhancing lesions tend to be less prevalent in progressive forms of multiple sclerosis. Furthermore, treatment with disease modifying therapies often results in near complete suppression of T₁ gadolinium contrast enhancing lesions in relapsing patients. As a result, instead of T₁ gadolinium contrast enhancing lesions, reliable quantification of new and enlarging T₂ lesions is generally used to monitor disease status and is an important secondary imaging and exploratory endpoint in examining neurological disorders including relapsing multiple sclerosis and primary progressive multiple sclerosis.

As noted, a T₂ lesion refers to a lesion that is present in a T₂-weighted scan generated by a magnetic resonance imaging sequence having a longer repetition time (TR) and time to echo (TE) than the magnetic resonance imaging (MRI) sequence used to generate T₁-weighted scans but a shorter repetition time (TR) and time to echo (TE) than the magnetic resonance imaging (MRI) sequence used to generate fluid attenuated inversion recovery (FLAIR) scans. For instance, while the T₁-weighted sequence may include a 500-millisecond repetition time (TR) and a 14-millisecond time to echo (TE), a T₂-weighted sequence may include a 40000-millisecond repetition time (TR) and a 90-second time to echo (TE) and a fluid attenuated inversion recovery (FLAIR) sequence may include a 9000-millisecond repetition time (TR) and a 114-millisecond time to echo (TE). The identification of new and enlarging T₂ lesions is challenging in neurological disorders such as multiple sclerosis. For example, new T₂ lesions tend to be small and in the immediate vicinity of an existing T₂ lesion. Meanwhile, enlarging T₂ lesions are often misconstrued as separate lesions due to their convoluted shape and breaks due to intensity variations within a T₂ lesion. Thus, there is a high degree of variability in the analysis of new and enlarging T₂ lesions.

While machine learning techniques, including deep learning techniques, have been used to identify T₂ lesions, conventional machine learning techniques are inadequate due to a large number of false positives (e.g., incorrectly identified new lesions and/or enlarging lesions), computational inefficiencies, and/or an inability to detect both new and enlarging T₂ lesions. For example, longitudinal tracking of lesions from serial magnetic resonance imaging sequences using classical image processing approaches to detect new and enlarging lesions generally employ strictly rule-based approaches applied to lesions detected cross-sectionally with a rigid or non-rigid registration to align images or change detection from subtraction maps. Though deformation maps provide valuable information for estimating lesion growth and shrinkage, accurate local registration of small lesions remains challenging. Independent lesion detection methods tend to be inconsistent when applied to capture serial changes due to the subtle intensity variations present in evolving lesions, the small size of new lesions, and tracking in convoluted three-dimensional structures. For purely rule-based approaches, it is difficult to accurately and consistently reproduce manual assessments, which tend to be subjective and frequently don't obey the same rules. To account for these limitations, supervised approaches using machine learning and recently deep learning models have been developed.

Various U-Net based deep learning models have generally operated on linearly registered baseline and follow-up images with attention on areas of T₂ lesions by preprocessing the input images and/or by using explicit attention blocks on features extracted from two encoders, which process the baseline and follow-up images separately and model the non-linear deformation with cascade models trained end-to-end. Sequential models have also been implemented. For example, an existing four-dimensional spatiotemporal model with a convolutional gated recurrent unit (cGRU) in the skip connection of a U-Net has been used to extract, from two or three input timepoints, spatial features followed by temporal features. In particular, the existing four-dimensional spatiotemporal model includes an encoder that processed all volumes individually and in parallel, aggregated across all timepoints using cGRUs, to generate an aggregated three-dimensional representation. The four-dimensional spatiotemporal model also includes a decoder that processed the aggregated three-dimensional representation for predicting a lesion activity map. As such, the four-dimensional spatiotemporal model relied on cGRUs for temporal aggregation between the encoder and decoder. However, similar to the other machine learning approaches mentioned above, the four-dimensional spatiotemporal model was inefficient and computationally expensive for widespread adoption and usage.

In some example embodiments, a machine learning controller consistent with implementations of the current subject matter may train and apply a machine learning model including, for example, a deep learning model such as a four-dimensional bidirectional convolutional gated recurrent unit, a lesion segmentation model, and/or the like. In some cases, the machine learning model may include one or more bidirectional sequential models capable of extracting temporal features indicative of nuanced changes between multitemporal image inputs from successive timepoints. Furthermore, the machine learning model may be combined with attention on lesion areas, for example, by using reference lesion masks (identifying lesions present at individual timepoints) to further reduce the false positives in the detection of new and enlarging lesions. In some cases, various examples of the machine learning model described herein may be applied to accurately and efficiently predict lesion activity, including those associated with a neurological disorder such as multiple sclerosis, while imposing a significantly lower computational burden than existing approaches. Moreover, while various examples of the machine learning model are described as being applied to detect new and enlarging T₂ lesions, which are lesions present in T₂-weighted scans, it should be appreciated that a same (or similar) approach may be applied towards detecting new and/or enlarging lesions in other types of magnetic resonance imaging (MRI) scans (e.g., T₁-weighted scans, fluid attenuated inversion recovery (FLAIR) scans, and/or the like).

In some example embodiments, the machine learning controller may train a machine learning model to identify one or more new lesions and/or enlarging lesions that developed within a multitemporal image input between a first timepoint and a second timepoint. As described herein, the multitemporal image input may include a first image acquired at the first timepoint and a second image acquired at the second timepoint. In some cases, the multitemporal image may be include a first magnetic resonance imaging (MRI) scan (e.g., a first T₁-weighted scan, a first T₂-weighted scan, and/or the like) from a first timepoint as well as a second magnetic resonance imaging (MRI) scan (e.g., a second T₁-weighted scan, a second T₂-weighted scan, and/or the like) from a second timepoint.

In some example embodiments, the machine learning controller may train the machine learning model to identify the one or more new lesions and/or enlarging lesions by at least generating a first representation of the multitemporal image input from the first timepoint to the second timepoint, generating a second representation of the multitemporal image input from the second timepoint to the first timepoint, generating a third representation of the multitemporal image input including a concatenation of the first representation and the second representation, and decoding the third representation of the multitemporal image input to generate a lesion mask identifying the one or more new lesions and/or enlarging lesions. In some cases, once the machine learning model is trained, the machine learning controller may apply the trained machine learning model to generate, for one or more images of a patient, a lesion mask identifying at least one of a new lesion and an enlarging lesion present in the one or more images. Moreover, in some cases, to further reduce the likelihood of false positives, the lesion mask generated by the trained machine learning model may undergo post-processing to verify whether the at least one of the new lesion and the enlarging lesion identified therein by the trained machine learning model is a false positive. In some cases, the trained machine learning model may become prone to generating a lesion mask with false positive identifications of new lesions and/or enlarging lesions when the multitemporal input images ingested by the trained machine learning model is out of the distribution of the multitemporal input images used to train the machine learning model. Accordingly, in addition to rejecting a lesion mask identified as containing false positive identifications of new lesions and/or enlarging lesions, the machine learning controller may further determine to retrain the machine learning model in instances where a threshold quantity of false positive identifications are detected through the post processing of lesion masks generated by the machine learning model.

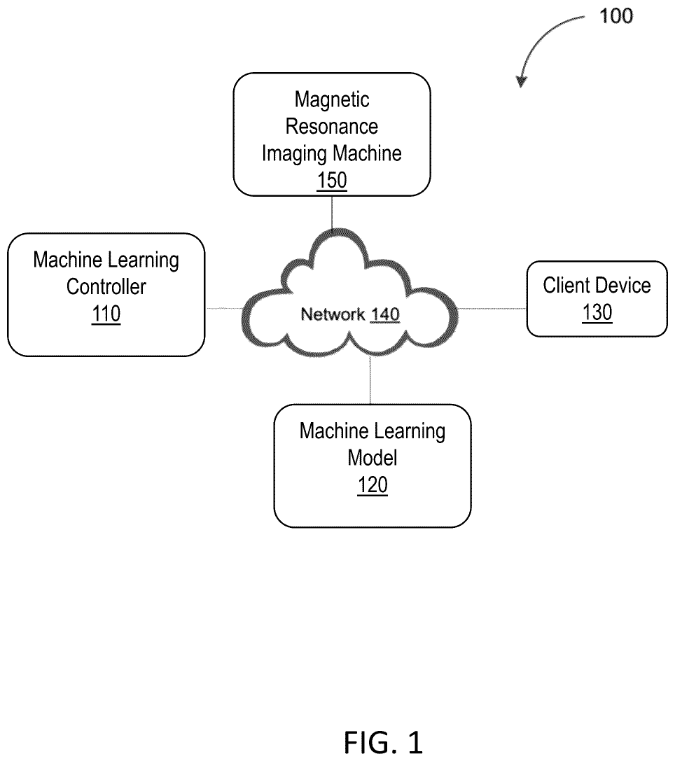

FIG. 1 depicts a system diagram illustrating an example of a lesion segmentation system 100, consistent with implementations of the current subject matter. Referring to FIG. 1, the lesion segmentation system 100 may include a machine learning controller 110, a first machine learning model 120, a client device 130, and a magnetic resonance imaging machine 150. The machine learning controller 110, the first machine learning model 120, and the client device 130 may be communicatively coupled via a network 140. The network 140 may be a wired network and/or a wireless network including, for example, a wide area network (WAN), a local area network (LAN), a virtual local area network (VLAN), a public land mobile network (PLMN), the Internet, and/or the like. In some implementations, the machine learning controller 110, the first machine learning model 120, and/or the client device 130 may be contained within and/or operate on a same device.

It should be appreciated that the client device 130 may be a processor-based device including, for example, a smartphone, a tablet computer, a wearable apparatus, a virtual assistant, an Internet-of-Things (IoT) appliance, and/or the like. The client device 130 may form a part of, include, and/or be coupled to the magnetic resonance imaging machine 150.

The magnetic resonance imaging machine 150 may generate an image, such as an image depicting at least a portion of a brain and/or a spinal cord of a patient. In some cases, the image may be a three-dimensional volume formed by a series of two-dimensional slices. Moreover, in some cases, the magnetic resonance imaging machine 150 apply a magnetic resonance imaging (MRI) sequence, which includes a certain length repetition time (TR) and time to echo (TE), to generate the image. For instance, in some cases, the image may be a T₂-weighted scan generated by the magnetic resonance imaging machine 150 applying a magnetic resonance imaging (MRI) sequence having a longer repetition time (TR) and time to echo (TE) than the magnetic resonance imaging (MRI) sequence used to generate T₁-weighted scans but a shorter repetition time (TR) and time to echo (TE) than the magnetic resonance imaging (MRI) sequence used to generate fluid attenuated inversion recovery (FLAIR) scans. Furthermore, in some cases, the image may be acquired by the magnetic resonance imaging (MRI) machine 150 prior to a gadolinium injection and/or subsequent to a gadolinium injection. It should be appreciated that the active lesions depicted in an image acquired post a gadolinium injection may exhibit a higher contrast than the active lesions depicted in an image acquired without a gadolinium injection.

The inputs generated by the magnetic resonance imaging machine 150 may be multitemporal that includes multiple images acquired at the same timepoint. the multitemporal inputs from different timepoints permits a comparison of the images from different timepoints to identify anatomical changes, including the development of new and/or enlarging lesions, that arise between the different timepoints. For instance, in some cases, the machine learning controller 110 may receive, from the magnetic resonance imaging machine 150, the multitemporal inputs from two consecutive timepoints. In some cases, the multitemporal input may include a first image from a first timepoint and a second image from a second timepoint. Moreover, in some cases, each of the first image and the second image may be a three-dimensional volume formed by a series of two-dimensional slices.

In some implementations, the machine learning controller 110 may train the first machine learning model 120 to identify one or more new lesions and/or enlarging lesions that developed between a first timepoint of a first image and a second timepoint of a second image. In some cases, the first image from the first timepoint may be acquired as a baseline image while the second image from the second timepoint may be acquired at a later time, such as during a follow-up.

In this context, a new lesion may refer to a lesion (e.g., a T₂ lesion) present in the second image from the second timepoint that is absent from the first image from the first timepoint. Accordingly, in some cases, a new lesion may be a lesion in the second image from the second timepoint whose overlap with a lesion mask from the first timepoint satisfies one or more first thresholds. For example, for a lesion in the second image from the second timepoint to be considered a new lesion, that lesion may not overlap the lesion mask from the first timepoint dilated by a threshold quantity of voxels (e.g., one voxel). Meanwhile, an enlarging lesion may be a lesion whose increase in dimensions (e.g., volume) across from the first timepoint and the second timepoint satisfies one or more second thresholds. It should be appreciated that an enlarging lesion is one that is present in both the first image from the first timepoint and the second image from the second timepoint. However, to be considered an enlarging lesion, a lesion that is present in both the first image from the first timepoint and the second image from the second timepoint may be required to exhibit a minimum increase in dimensions (e.g., a three-fold increase in volume) between the first timepoint and the second timepoint. The one or more second thresholds (e.g., the three-fold difference) may be a set to a value that minimizes the false positives associated with the improper classification of an existing lesion. It should be appreciated that different values may be used for the one or more second thresholds (e.g., a 1.5 difference, a two-fold difference, a four-fold difference, a five-fold difference, and/or the like). Moreover, in some cases, the likelihood of false positives may be further reduced by imposing one or more third thresholds on the dimensions (e.g., one or more minimum dimensions) on any new or enlarging lesions identified within the multitemporal input. For instance, in some cases, to be considered a new lesion or an enlarging lesion, a lesion may be required to span a threshold quantity of voxels (e.g., 1 voxel, 2 voxels, 3 voxels, 4 voxels, 5 voxels, and/or the like). In some cases, the values of the aforementioned thresholds may be indication specific. That is, the one or more first, second, and third thresholds may be set to values consistent with the dimensions (or changes in dimensions) observed with a particular disease or condition such as multiple sclerosis.

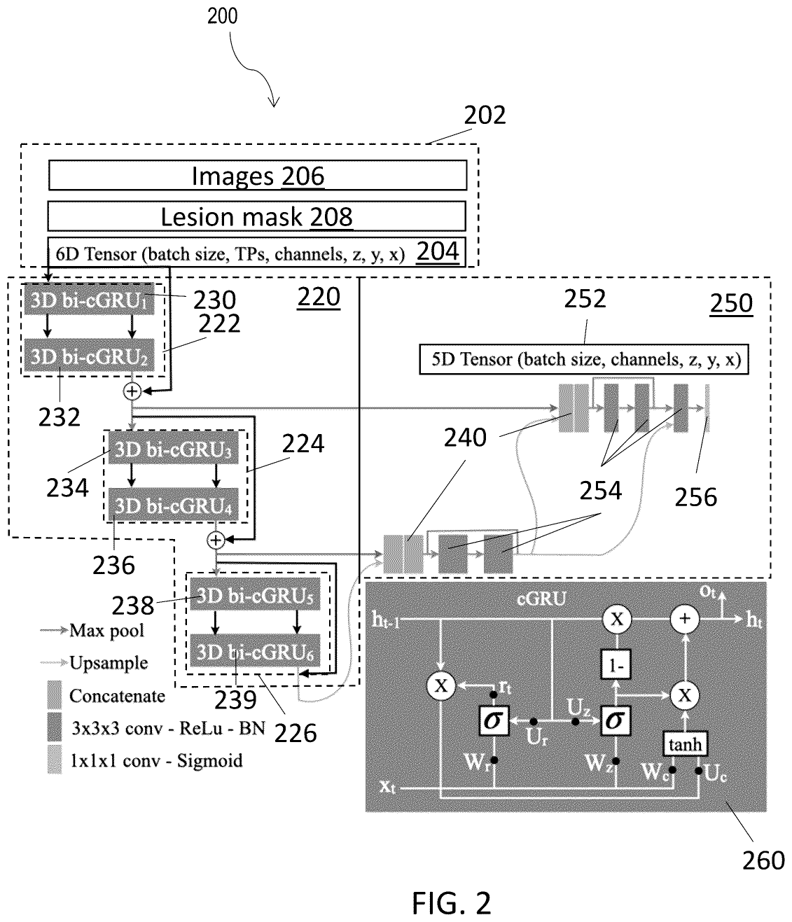

FIG. 2 schematically illustrates an example architecture 200 of the first machine learning model 120. The machine learning controller 110 may train the first machine learning model 120 having the architecture 200.

As noted above, the machine learning controller 110 trains the first machine learning model 120 based on the multitemporal input 202, which may include a first image acquired at least at a first timepoint and a second image acquired at a second timepoint (or other timepoints). The first timepoint and the second timepoint may be the timepoints at which the images were acquired by the magnetic resonance imaging machine 150. For example, the first timepoint may be at time zero. In other words, the first timepoint may be a baseline or initial time at which the images were acquired. The second timepoint may be a time that is later than the first timepoint. The second timepoint may be a number of minutes, hours, weeks, months, or the like after the first timepoint. In some implementations, the second timepoint is 24 weeks, 48 weeks, 96 weeks, or the like after the first timepoint.

In some cases, the images 206 may be acquired by the magnetic resonance imaging machine 150 applying a specific magnetic resonance imaging (MRI) sequence such as, for example, a T₁-weighted sequence, a T₂-weighted sequence, a fluid attenuated inversion recovery (FLAIR) sequence, and/or the like. Different magnetic resonance imaging (MRI) sequences may exhibit different lengths repetition time (TR) and time to echo (TE) to generate different types of magnetic resonance imaging (MRI) scans. For example, the T₂-weighted sequence may exhibit a longer repetition time (TR) and time to echo (TE) than the T₁-weighted sequence but a shorter repetition time (TR) and time to echo (TE) than the fluid attenuated inversion recovery (FLAIR) sequence. Accordingly, as described herein, the images 206 may include the T₁-weighted images, T₂-weighted images, the fluid attenuated inversion recovery (FLAIR) images, and/or the like.

Additionally and/or alternatively, the multitemporal image input 202 may include a six-dimensional tensor 204. The six-dimensional tensor 204 helps to ensure consideration of the temporal dimension for learning by the first machine learning model 120. The six-dimensional tensor 204 includes a batch size, at least two timepoints (referred to as “TPs” in FIG. 2), at least one channel, and/or at least one spatial coordinate (referred to as “z, y, x” in FIG. 2). The batch size may include a number of samples provided as part of the multitemporal image input. The timepoint may include the concatenation of multitemporal inputs from two timepoints associated with the acquired image or images (e.g., the first image and/or the second image). Specifically concatenation of multitemporal inputs from the timepoints associated with the acquired images multitemporal may help to improve the accuracy of identifying new and/or enlarging lesions. For example, this may ensure explicit consideration of and learning based on the changes between the first timepoint and the second timepoint. The at least one channel may include the particular modality or modalities that was used to acquire the at least one image. The at least one spatial coordinate may include the x-coordinate, the y-coordinate, and/or the z-coordinate associated with the new and/or enlarging lesions in the at least one image.

Additionally and/or alternatively, the multitemporal image input 202 may include a reference lesion mask 208 identifying one or more existing lesions present in the images 206 (e.g., the first image and/or the second image, etc.). For example, in some cases, the reference lesion mask 208 may include a plurality of voxels, each of which be associated with either a first value (e.g., “1”) to indicate that the voxel is a part of a lesion or a second value (e.g., “0”) to indicate that the voxel is not a part of a lesion. Where each of the one or more images 206 is a three-dimensional volume formed by a series of two-dimensional slices, a single voxel in the three-dimensional volume may correspond to a single pixel one of the constituent two-dimensional slices. Accordingly, the reference lesion mask 208 may provide attention to the one or more existing lesions, further improving the accuracy of the first machine learning model 120 in identifying the one or more new lesions and/or enlarging lesions. In some implementations, the reference lesion mask 208 may be applied to one or more of the images 206, such as one, two, or all of the images 206. That is, in some cases, the reference lesion mask 208 may include one or multiple reference lesion masks, each of which being associated with one of the images 206. In some implementations, the lesions are segmented cross-sectionally as part of the multitemporal image input 202 for providing attention to the one or more existing lesions.

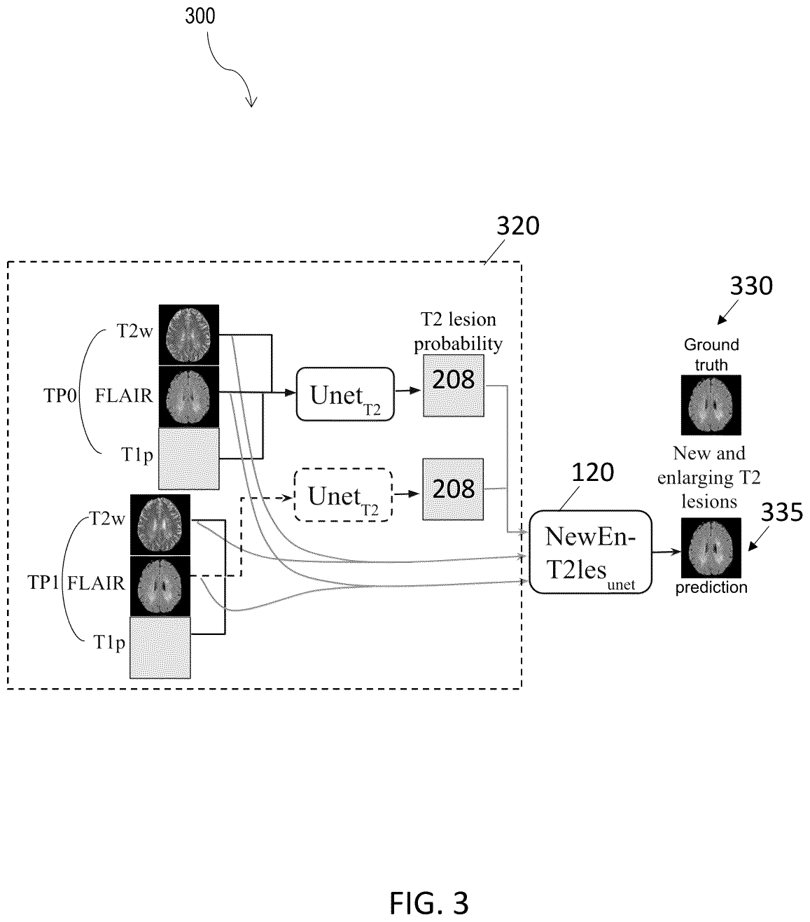

In some cases, the reference lesion mask 208, including the labels assigned to the voxels in the reference lesion mask 208 to identify those that are a part of a lesion and those that are part of the background, may be generated based on expert annotations. Additionally and/or alternatively, the reference lesion mask 208 may be generated by applying another (e.g., a second) machine learning model 320 (see FIG. 3). The second machine learning model 320 may be pre-trained based on a cross-sectional magnetic resonance imaging sequence and an annotation of the cross-sectional magnetic resonance imaging sequence. Thus, the reference lesion mask 208 included as part of the multitemporal image input 202 may be generated by a pre-trained machine learning model 320. The machine learning model 120 and the second machine learning model 320 may be chained such that an output of the second machine learning model 320 is provided as an input to the first machine learning model 120. In some implementations, such as when the first machine learning model 120 and the second machine learning model 320 are chained, the first machine learning model 120 and the second machine learning model 320 may be jointly trained. For example, the first machine learning model 120 and the second machine learning model 320 may be jointly trained by at least backpropagating a loss associated with incorrectly identifying the one or more new and/or enlarging lesions through the first machine learning model 120 and the second machine learning model 320 (e.g., the difference between a ground truth lesion mask 330 and a predicted lesion mask 335). Additionally, the segmentation loss of the second machine learning model 320 may also be backpropagated.

In some implementations, the multitemporal image input 202 may be a part of a training sample that also includes a ground truth lesion mask having one or more ground truth annotations. For example, the ground truth lesion mask may include expert annotations (e.g., made by an expert, physician, and/or the like) in which a voxel that is a part of a new lesion is annotated with a first value, a voxel that is a part of an enlarging lesion is annotated with a second value, and a voxel that is a part of a background or an existing, non-enlarging lesion is annotated with a third value. Alternatively, the ground truth lesion mask may include separate new and enlarging lesion masks, in which case the voxels corresponding to a new lesion in the ground truth new lesion mask and the voxels corresponding to an enlarging lesion in the ground truth enlarging lesion mask may be annotated with a first value (e.g., “1”) while the background voxels in those two masks may be annotated with a second value (e.g., “0”). In some cases, the ground truth lesion mask including the ground truth annotations may be used during the training of the first machine learning model 120. For instance, one or more parameters (e.g., weights) of the first machine learning model 120 may be adjusted during the training of the first machine learning model 120 to minimize a difference between the ground-truth lesion mask and the lesion mask output by the first machine learning model 120 operating on the multitemporal image input 202.

As an example, FIG. 3 schematically illustrates an example architecture 300 of the second machine learning model 320 chained to the first machine learning model 120. As shown in FIG. 3, instead of using the lesion masks from the previously trained model (e.g., the second machine learning model 320) as an additional input for the first machine learning model 120 (labeled “NewEn-T2lesᵤₙₑₜ” in FIG. 3), the first machine learning model 120 is shown as being chained with the pre-trained second machine learning model 320 serially. In this example, the lesion probabilities predicted by the second machine learning model 320 (e.g., the lesion segmentation model) were fed directly as an input to the first machine learning model 120. In this example, the first machine learning model 120 and the second machine learning model 320 were pre-trained independently and trained jointly with reduced learning rates. For example, the first machine learning model 120 and the second machine learning model 320 were trained in an end-to-end fashion where the loss corresponding to the incorrect identification of new and enlarging lesion were backpropagated through both the first machine learning model 120 and the second machine learning model 320 while the segmentation loss of incorrectly segmenting lesions at individual timepoints were backpropagated through the second machine learning model 320 only.

Referring to the architecture 300, the sensitivity of new and/or enlarging lesion detection and segmentation improved with end-to-end training. As shown in Table 1, the lesion detection sensitivity improved with a slight reduction in lesion false positive rate (LFPR) compared to the results of the first model in Tables 2 and 3.

TABLE 1

| Model | | DC | PPV | TPR | rᵥₒₗ |
|---|---|---|---|---|---|
| Unet_{T2} | Segmen- | 0.598 ± 0.207 | 0.548 ± 0.214 | 0.747 ± 0.26 | 0.921 |
| (second) | tation | | | | |
| NewEn- | | 0.677 ± 0.125 | 0.724 ± 0.16 | 0.668 ± 0.146 | 0.966 |
| T2lesᵤₙₑₜ | | | | | |
| (first) | | | | | |
| | | LFPR | LPPV | LTPR | r_{count} |
| Unet_{T2} | Detection | 0.32 ± 0.282 | 0.694 ± 0.283 | 0.917 ± 0.222 | 0.902 |
| NewEn- | | 0.167 ± 0.133 | 0.742 ± 0.155 | 0.868 ± 0.12 | 0.951 |
| T2lesᵤₙₑₜ | | | | | |

Referring back to FIG. 2, FIG. 2 schematically illustrates an example architecture 200 of the first machine learning model 120. The first machine learning model 120 may include a four-dimensional spatiotemporal U-Net, and/or the like. The machine learning controller 110 may train the first machine learning model 120 using an encoder 220 including one or more encoding blocks and a decoder 250. For example, for segmenting new and enlarging T₂ lesions in multiple sclerosis, the architecture 200 includes at least one U-Net with stacked bi-directional cGRU blocks in the encoding path (e.g., using the encoder 220) to generate a representation, and convolutional layers in the decoding path (e.g., using the decoder 250) to decode the representation.

Consistent with implementations of the current subject matter, the first machine learning model 120 may include at least one cGRU used for extracting temporal features during the encoding. The at least one cGRU is beneficial for temporal modeling because of the limited number of timepoints (e.g., two timepoints, or the like). However, in some implementations, a long short-term memory layer may be used in place of the at least one cGRU. The at least one cGRU replaces the matrix multiplications with convolutions and is well suited to capture the local structure in images, such as the images 206. The intermediate and final representations of the cGRU are represented by representation 260 in FIG. 2. Representation 260 corresponds to Equations (1)-(4), which are shown below:

$${Z}_{t} = σ ( {U}_{z} * {h}_{t - 1} + {W}_{z} * {x}_{t} ) \qquad Equation 1$$

$${r}_{t} = σ ( {U}_{r} * {h}_{t - 1} + {W}_{r} * {x}_{t} ) \qquad Equation 2$$

$${c}_{t} = tanh ( {U}_{c} * ( {r}_{t} {h}_{t - 1} ) + {W}_{c} * {x}_{t} ) \qquad Equation 3$$

$${h}_{t} = {Z}_{t} {C}_{t} + ( 1 - {Z}_{t} ) {h}_{t - 1} \qquad Equation 4$$

In Equations (1)-(4), h denotes the hidden state, x is the input, * denotes the convolution operation, U and W correspond to convolution filters, and σ denotes the sigmoid activation function. For four-dimensional spatiotemporal modeling on multitemporal magnetic resonance imaging images, the cGRU received a six-dimensional tensor as input (e.g., the six-dimensional tensor 204), and used three-dimensional convolutions with dropout for regularization and layer normalization. As shown in FIG. 3, a bi-directional cGRU was implemented in the architecture 200. In the bi-directional cGRU, a forward unidirectional cGRU processed the multitemporal image input 202 from timepoints 0 (a first timepoint) to 1 (a second timepoint) and a reverse unidirectional cGRU processed the multitemporal image input 202 from timepoints 1 to 0. The representations from both unidirectional cGRUs were concatenated, such as along a channel dimension, for the final output.

For example, as noted above, the architecture 200 includes an encoder 220 and a decoder 250. The encoder 220 and the decoder 250 had residual connections and the architecture of the connections was three levels deep. The features extracted during the encoding were down sampled using max pooling layers and up sampled using interpolation layers. The encoder 220 may encode the multitemporal image input 202 based on at least the six-dimensional tensor 204. The encoder 220 includes at least one bi-directional cGRU block that encodes the multitemporal image input 202. For example, at least one bi-directional cGRU block includes a first bi-directional cGRU block 222, a second bi-directional cGRU block 224, and a third bi-directional cGRU block 226. While the encoder 220 is shown as having three bi-directional cGRU blocks, other configurations may include one, two, three, four, five, six, or more bi-directional cGRU blocks.

Referring to FIG. 2, the at least one bi-directional cGRU block may be cascaded. In other words, a representation generated by one bi-directional cGRU block may be combined (e.g., concatenated or the like) with a representation generated by another bi-directional cGRU block, and may be fed as at least a part of an input to the next bi-directional cGRU block. As an example, a representation generated by the first bi-directional cGRU block 222 may be fed as at least a part of an input to the second bi-directional cGRU block 224. Similarly, a representation generated by the second bi-directional cGRU block 224 may be fed as at least a part of an input to the third bi-directional cGRU block 226. The representations generated by the first bi-directional cGRU block 222, the second bi-directional cGRU block 224, and/or the third bi-directional cGRU block 226 may be combined.

The first bi-directional cGRU block 222, the second bi-directional cGRU block 224, and the third bi-directional cGRU block 226 may each include a pair of bi-directional cGRUs. For example, the first bi-directional cGRU block 222 may include a first bi-directional cGRU 230 and a second bi-directional cGRU 232. The second bi-directional cGRU block 224 may include a first bi-directional cGRU 234 and a second bi-directional cGRU 236. The third bi-directional cGRU block 226 may include a first bi-directional cGRU 238 and a second bi-directional cGRU 239. Each of the bi-directional cGRUs within each bi-directional cGRU block may be stacked. For example, the first bi-directional cGRU 230 may be stacked with the second bi-directional cGRU 232, first bi-directional cGRU 234 may be stacked with the second bi-directional cGRU 236, and first bi-directional cGRU 238 may be stacked with the second bi-directional cGRU 239. In other words, a representation generated by one bi-directional cGRU (e.g., the first bi-directional cGRU 230, 234, 238) may be fed to a respective other bi-directional cGRU (e.g., the respective second bi-directional cGRU 232, 236, 239).

Each pair of stacked bidirectional cGRUs at a given level (e.g., within each corresponding bi-directional cGRU block) extracts features at a given resolution. Even though the second bi-directional cGRU (e.g., the second bi-directional cGRU 232, 236, 239) in the corresponding bi-directional cGRU block (e.g., the bi-directional block 222, 224, 226) may use dilated convolution, the receptive field (e.g., the area and/or volume of the input of the bi-directional cGRU block) is not generally large. For example, the encoder 220 may see a 7×7×3 patch in the input volumes which in some instances can be sufficient to detect new lesions (e.g., new T₂ lesions and/or the like). To improve the extraction of features for enlarging lesions (e.g., enlarging T₂ lesions and/or the like), such as lesions exhibiting an increase in dimensions satisfying one or more thresholds, as noted above, the first bi-directional cGRU block 222, the second bi-directional cGRU block 224, and the third bi-directional cGRU 226, which each may include stacked bi-directional cGRUs may be cascaded at a plurality (e.g., two, three, four or more) levels and/or resolutions.

Each of the bi-directional cGRUs (e.g., the first bi-directional cGRUs 230, 234, 238 and the second bi-directional cGRUs 232, 236, 239) includes two unidirectional cGRUs (not shown). For example, the first bi-directional cGRU 230 includes a first unidirectional cGRU and a second unidirectional cGRU. The second bi-directional cGRU 232 includes a first unidirectional cGRU and a second unidirectional cGRU. The first bi-directional cGRU 234 includes a first unidirectional cGRU and a second unidirectional cGRU. The second bi-directional cGRU 236 includes a first unidirectional cGRU and a second unidirectional cGRU. The first bi-directional cGRU 238 includes a first unidirectional cGRU and a second unidirectional cGRU. The second bi-directional cGRU 239 includes a first unidirectional cGRU and a second unidirectional cGRU.

The first unidirectional cGRU of each pair of cGRUs generates a first representation of the multitemporal image input 202 representing an encoding of the multitemporal image input 202 from a first timepoint (e.g., a baseline timepoint) to a second timepoint after the first timepoint. That is, in some cases, the first representation of the multitemporal image input 202 may be a first encoding of a first change between the first image from first timepoint in the multitemporal image input 202 and the second image from the second timepoint in the multitemporal image input 202. Accordingly, during generation of the first representation of the multitemporal image input 202, the encoder 220 may extract a first set of temporal features present in the multitemporal image input from the first timepoint to the second timepoint.

In some cases, the second unidirectional cGRU of each pair of cGRUs generates a second representation of the multitemporal image input 202 representing an encoding of the multitemporal image input 202 from the second timepoint to the first timepoint. For example, in some cases, the second representation of the multitemporal image input 202 may be a second encoding of a second change between the second image from the second timepoint in the multitemporal image input 202 and the first image from the first timepoint in the multitemporal image input 202. During generation of the second representation of the multitemporal image input 202 the encoder 220 may extract a second set of temporal features present in the multitemporal image input 202 from the second timepoint to the first timepoint. The first set and the second set of temporal features may be extracted to help identify new and/or enlarging lesions. For instance, in some cases, the first machine learning model 120 may operate on the extracted first set and second set of temporal features to identify temporal differences between the first image acquired at the first timepoint and the second image acquired at the second timepoint.

The encoder 220 may further generate a third representation of the multitemporal image input 202. For example, in some cases the encoder 220 may combine the temporal features extracted during the generation of the first representation and/or the second generation. The encoder 220 may additionally and/or alternatively concatenate the first representation generated by the first unidirectional cGRU and the second representation generated by the second unidirectional cGRU.

The third representation of the multitemporal image input 202 may be forwarded along skip connection as a five-dimensional tensor 252, upon removing the time dimension. The five-dimensional tensor 252 may be used by the decoder 250 to decode the third representation of the multitemporal image input 202. The decoding of the third representation of the multitemporal image input 202 may generate an output lesion mask in which the new lesions and/or enlarging lesions present in the multitemporal image input 202 are identified by the labels associated with each voxel in the output lesion mask. For example, in some cases, a voxel that is a part of a new lesion may be labeled with a first value in the output lesion mask, a voxel that is a part of an enlarging lesion may be labeled with a second value in the output lesion mask, and a voxel that is a part of a background or an existing, non-enlarging lesion may be annotated with a third value in the output lesion mask. Alternatively, the output lesion mask may include a new lesion mask and an enlarging lesion mask. In the new lesion mask, the voxels corresponding to a new lesion may be labeled with a first value (e.g., “1”) while the background voxels (e.g., voxels corresponding to non-new lesions) are labeled with a second value (e.g., “0”). Meanwhile, in the enlarging lesion mask, the voxels corresponding to an enlarging lesion may be labeled with a first value (e.g., “1”) and the background voxels (e.g., voxels corresponding to non-enlarging lesions) may be labeled with a second value (e.g., “0”). Alternatively, the output lesion mask may include a new and an enlarging lesion mask, where voxels corresponding to new and enlarging lesions may be labeled with a first value (e.g., “1”) and the background voxels are labeled with a second value (e.g., “0”). The five-dimensional tensor 252 includes a batch size, at least one channel, and/or at least one spatial coordinate (referred to as “z, y, x” in FIG. 2). The batch size may include the number of samples provided as part of the multitemporal image input 202 and may be the same as the batch size of the six-dimensional tensor 204. The at least one channel may include the features extracted by the first bi-directional cGRU block 222, the second bi-directional cGRU block 224, and the third bi-directional cGRU block 226 and may be the same as the at least one channel of the six-dimensional tensor 204. The at least one spatial coordinate may include the x-coordinate, the y-coordinate, and/or the z-coordinate associated with the new and/or enlarging lesions in the at least one image.

Referring again to FIG. 2 and as described herein, the second bi-directional cGRU block 224 may include a pair of bi-directional cGRUs (e.g., a first bi-directional cGRU and a second bi-directional cGRU), each of which includes a first unidirectional cGRU and a second unidirectional cGRU. The third bi-directional cGRU block 226 may include a pair of bi-directional cGRUs (e.g., a first bi-directional cGRU and a second bi-directional cGRU), each of which includes a first unidirectional cGRU and a second unidirectional cGRU. A representation may be generated by each of the second and third bi-directional cGRU block 224, 226 by at least concatenating the representations generated by each of the corresponding unidirectional cGRUs.

Again referring to FIG. 2, the decoder 250 may include one or more convolutional layers. The one or more convolutional layers of the decoder 250 are configured to decode the third representation of the multitemporal image input. The third representation from the encoding blocks forwarded along the skip connections may be concatenated with an up-sampled representation learned in the decoder 240. In some implementations, the one or more convolutional layers includes a filter, such as a 1×1×1 filter 256, a 3×3×3 filter 254, and/or the like. As noted, the decoder 250 may generate an output lesion mask identifying one or more new and/or enlarging lesions. In some cases, the output lesion mask may correspond to a decoding of the third representation of the multitemporal image input 202. In other words, the decoder 250 may generate the lesion mask by at least decoding the third representation of the multitemporal image input 202. The output lesion mask may identify one or more new and/or enlarging lesions that may have developed between the timepoints, such as the first timepoint and the second timepoint. As described in more detail below, the output lesion mask may undergo post processing in order to verify the one or more new and/or enlarging lesions identified by the lesion mask. In some cases, the post processing may include the detection of false positives which, in this context, may refer to one or more voxels in the lesion mask that are incorrectly labeled as being a part of a new lesion, an enlarging lesion, the background, and/or a non-enlarging lesion.

In some implementations, the temporal features may be extracted prior to the spatial features. For example, as described herein, sets (e.g., a first set, a second set, and/or the like) of temporal features may be extracted by the encoder 220 during the generation of the first representation and/or the second representation. In this context, a spatial feature is a feature present in an image (e.g., a three-dimensional magnetic resonance imaging (MRI) scan) from a single timepoint whereas a temporal feature is a feature that is present across two or more images (e.g., two or more three-dimensional magnetic resonance imaging (MRI) scans) from multiple timepoints. For instance, while a spatial feature may include a certain distribution of voxel intensity values in an image (e.g., a three-dimensional magnetic resonance imaging (MRI) scan) from a single timepoint, a temporal feature may include a change in the distribution of voxel intensity values that is observed in two or more images (e.g., two or more three-dimensional magnetic resonance imaging (MRI) scans) from multiple timepoints. The extracted temporal features may be combined and refined spatially with the one or more convolutional layers of the decoder 250. Thus, the spatial features may be extracted or otherwise refined after the temporal features are extracted. This may improve performance of the first machine learning model 120 in identifying new and/or enlarging lesions. In some implementations, the temporal features and the spatial features are extracted and/or refined at the same time, such as when using the architecture 300 shown in FIG. 3. Using the example architecture 300 shown in FIG. 3, the serial configuration of the first machine learning model 120 and the second machine learning model 320 may extract such features simultaneously, at least because the first machine learning model 120 and the trained second machine learning model 320 may be chained.

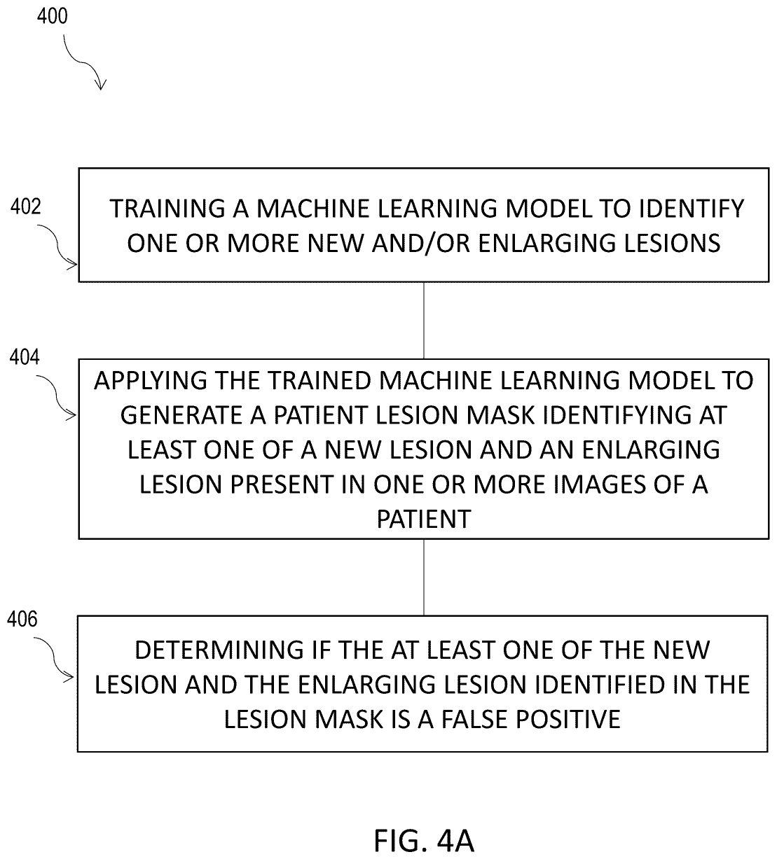

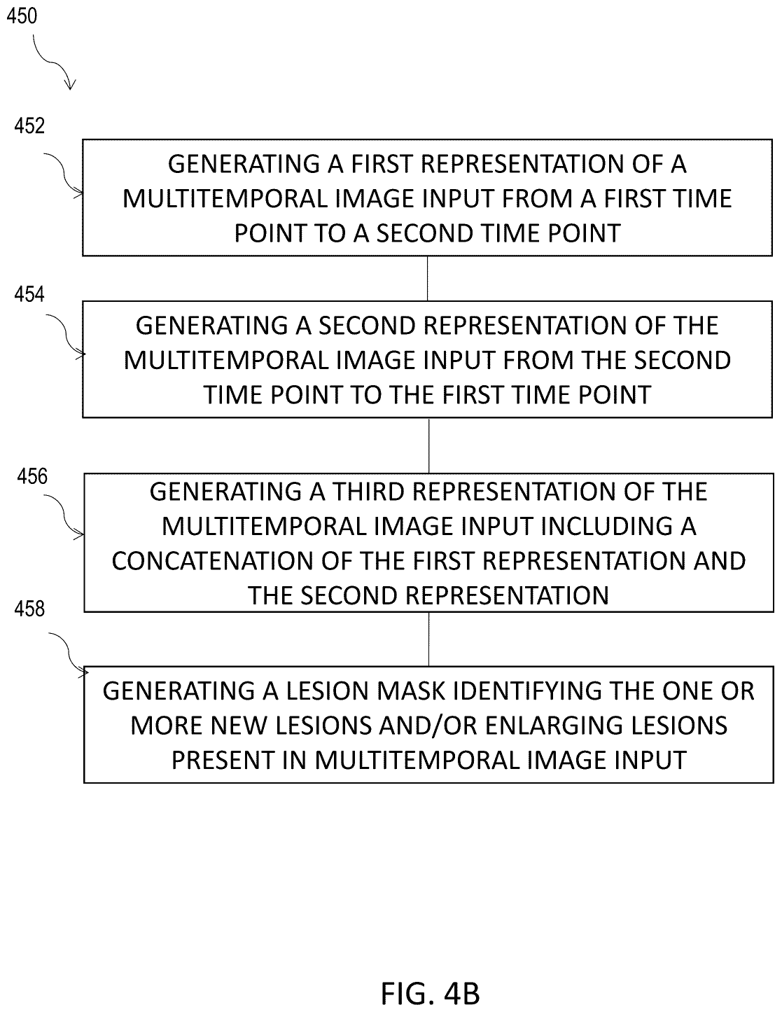

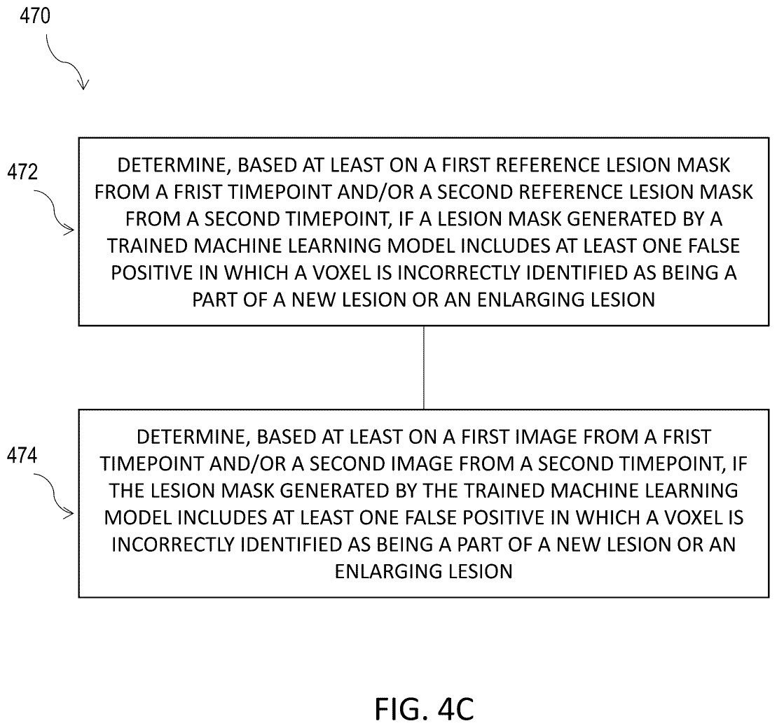

FIGS. 4A-C depict flowcharts illustrating an example of processes 400, 450, and 470 for deep learning based detection of new and enlarging lesions (e.g., T₂ lesions), consistent with implementations of the current subject matter. Referring to FIGS. 4A-C, the processes 400, 450, and 470 may be performed by the machine learning controller 110 to generate a lesion mask identifying one or more new lesions and/or enlarging lesions. The machine learning controller 110 may thus train the first machine learning model 120 to identify one or more new lesions and/or enlarging lesions with improved accuracy, efficiency, and a reduction in computational resource requirements. Consistent with implementations of the current subject matter, the processes 400, 450, and 470 refer to the example architectures 200, 300 shown in FIG. 2 and FIG. 3.

Referring to FIG. 4A, at 402, the machine learning controller (e.g., the machine learning controller 110) may train a machine learning model (e.g., the first machine learning model 120) to identify the one or more new lesions and/or enlarging lesions that developed within the multitemporal image input 202 between a first timepoint and a second timepoint. For example, the multitemporal image input 202 may include the images 206, which may include a first image acquired at the first timepoint and a second image acquired at the second timepoint. In some cases, the first image and the second image may be three-dimensional magnetic resonance imaging (MRI) scans captured using a certain magnetic resonance imaging (MRI) sequence such as, for example, a T₁-weighted sequence, a T₂-weighted sequence, or a fluid attenuated inversion recovery (FLAIR) sequence, and/or the like. As described in more details below, the first machine learning model 120 may be trained to operate on the images 206 in the multitemporal image input 202 to generate an output lesion mask that identifies one or more new lesions and/or enlarging lesions that have developed between the first timepoint and the second timepoint. In some cases, the multitemporal image input 202 may additionally and/or alternatively include the six-dimensional tensor 204 including a batch size, a timepoint (e.g., the first timepoint and/or the second timepoint), channels, and spatial coordinates. The first machine learning model 120 may be further trained to operate on the six-dimensional tensor 204 when generating the output lesion mask. The inclusion of the six-dimensional tensor 204 may ensure that the temporal features of the images 206 are explicitly considered by the first machine learning model 206.

In some implementations, the multitemporal image input 202 may include the reference lesion mask 208, such as a reference lesion mask identifying one or more existing lesions present in the first image and/or the second image. For instance, in some cases, the reference lesion mask 208 may include a first reference lesion mask identifying one or more lesions present in the first image and/or a second reference lesion mask identifying one or more lesions present in the second image. The reference lesion mask 208 may provide attention to the one or more existing lesions. The reference lesion mask 208 may be generated based on expert annotations identifying one or more of the lesions (e.g., the constituent voxels) present in the first image and/or the second image. The reference lesion mask 208 may additionally and/or alternatively be generated by applying a second machine learning model (e.g., the second machine learning model 320). The second machine learning model 320 may be pre-trained based on a cross-sectional magnetic resonance imaging sequence and an annotation of the cross-sectional magnetic resonance imaging sequence. Alternatively and/or additionally, the first machine learning model 120 and the second machine learning model 320 may be chained such that an output of the second machine learning model 320 is provided as an input to the first machine learning model 120. The first machine learning model 120 and the second machine learning model 320 may be jointly trained including by at least backpropagating a loss associated with incorrectly identifying the one or more new lesions and/or enlarging lesions through the first machine learning model 120 and the second machine learning model 320 and a segmentation loss corresponding to reference lesion masks through the second machine learning model 320 only.

multitemporalmultitemporalmultitemporalmultitemporalmultitemporalmultitem poralmultitemporalmultitemporalmultitemporalmultitemporalmultitemporalAt 404, the machine learning controller 110 may apply the trained first machine learning model 120 to generate, for one or more images of a patient, a lesion mask identifying at least one of a new lesion and an enlarging lesion present in the one or more images. In some cases, the lesion mask identifying at least one of a new lesion and an enlarging lesion may be applied to assess the activity, progression, and treatment response for a variety of neurological disorders, such as multiple sclerosis.

At 406, the machine learning controller 110 may determine if the at least one of the new lesion and the enlarging lesion identified in the lesion mask is a false positive. In some example embodiments, the machine learning controller 110 may perform post processing in order to detect, in the lesion mask, one or more false positives that includes the misidentification of a new lesion and/or an enlarging lesion in the multitemporal image input 202. In this context, a false positive may include a voxel in the lesion mask that is annotated as being a part of a new lesion when that voxel is a part of an existing lesion or is a background voxel that is not a part of a lesion at all. In some cases, a false positive may also include a voxel in the lesion mask that is annotated as being a part of an enlarging lesion when that voxel is a background voxel, a part of a new lesion, or a part of a non-enlarging lesion (e.g., a lesion whose change in dimensions fails to satisfy one or more thresholds). As described in more detail below, in some cases, the post processing may include the machine learning controller 110 analyzing the lesion mask (e.g., generated by the trained machine learning model 120 at operation 404) and the multitemporal image input 202 (e.g., the images 206, the reference lesion mask 208, and/or the like) to determine whether the one or more new lesion and/or enlarging lesions in the lesion mask is a false positive. In instances where the machine learning controller 110 identifies, within the lesion mask, a threshold quantity of false positives, the machine learning controller 110 may reject the lesion mask from being used in downstream clinical tasks. Furthermore, in cases where the machine learning controller 110 detects the occurrence of false positives in a threshold quantity of lesion masks generated by the trained first machine learning model 120, the machine learning controller 110 may determine that the first machine learning model 120 is unsuitable for the current set of multitemporal image inputs whose distribution may exhibit an excessive deviation from the distribution of the training data used to train the first machine learning model 120. In some cases, the machine learning controller 110 may determine to retrain the first machine learning model 120 if the machine learning controller 110 detects the occurrence of false positives in a threshold quantity of lesion masks generated by the trained first machine learning model 120.

FIG. 4B depicts a flowchart illustrating an example of a process 450 in which a machine learning model operates on a multitemporal image input that includes images from multiple timepoints to generate a lesion mask identifying one or more new lesions and/or enlarging lesions (e.g., T2 lesions) present in the multitemporal image input. Referring to FIGS. 4A-B, the process 450 may be performed by the first machine learning model 120 when the machine learning controller 110 trains the first machine learning model 120 or when the machine learning controller 110 applies the trained first machine learning model 120. In some cases, the process 450 may implement operation 402 or 404 of the process 400 shown in FIG. 4A.

At 452, the machine learning model 120 may generate a first representation of the multitemporal image input 202 from the first timepoint to the second timepoint. For example, when applied to the multitemporal image input 202, the first machine learning model 120 may generate the first representation of the multitemporal image input 202 by at least extracting a first set of temporal features present in the multitemporal image input 202 from the first timepoint to the second timepoint.

At 454, the machine learning model 120 may generate a second representation of the multitemporal image input 202 from the second timepoint to the first timepoint. Generating the second representation of the multitemporal image input 202 may include extracting a second set of temporal features present in the multitemporal image input 202 from the second timepoint to the first timepoint. The first representation and the second representation may be generated by a bi-directional cGRU (e.g., the first bi-directional cGRU block 222, the second bi-directional cGRU block 224, the third bi-directional cGRU block 226, etc.). The bi-directional cGRU may include a first unidirectional cGRU that generates the first representation and a second unidirectional cGRU that generates the second representation. The first representation and the second representation are encodings of the multitemporal image input. For example, as described herein, the first machine learning model 120 may include an encoder 220 that encodes the multitemporal image input using the bi-directional cGRU blocks.

At 456, the machine learning model 120 may generate a third representation of the of the multitemporal image input 202. Generation of the third representation may improve the accuracy of identifying new and/or enlarging lesions. In some cases, the first machine learning model 120 may generate the third representation by at least concatenating the first representation and the second representation. Moreover, in some cases, the third representation of the multitemporal image input 202, which is generated by concatenating the first representation and the second representation of the multitemporal image input 202, may include a five-dimensional tensor including a batch size, channels, and spatial coordinates.

At 458, the machine learning controller 110 generates a lesion mask identifying the one or more new lesions and/or enlarging lesions present in the multitemporal image input 202. In some cases, the third representation of the multitemporal image input 202 (e.g., the five-dimensional tensor generated at operation 456 by at least concatenating the first representation and the second representation of the multitemporal image input 202) may be decoded in order to generate the lesion mask identifying one or more new lesions and/or enlarging lesions present in the multitemporal image input 202. For example, in some cases, the first machine learning model 120 includes the decoder 250, which may include one or more convolutional layers configured to decode the third representation of the multitemporal image input 202. Accordingly, the lesion mask generated at operation 458 may, in some cases, correspond to a decoding of the third representation of the multitemporal image input 202. The lesion mask may accurately indicate new and/or enlarging lesions including, for example, T₂ lesions and/or the like. For instance, in some cases, the lesion mask may include a plurality of voxels, each of which being labeled with a first value to indicate the voxel as being a part of a new lesion, a second value to indicate the voxel as being a part of an enlarging lesion, or a third value to indicate the voxel as being a part of the background or a non-enlarging lesion. Alternatively, instead of a single lesion mask, separate new lesion and enlarging lesion masks may be generated by the decoding of the third representation of the multitemporal image input 202. The new lesion mask may include a plurality of voxels, each of which being labeled with a first value (e.g., “1”) if the voxel is a part of a new lesion and a second value (e.g., “0”) if the voxel is a background voxel that is not part of a new lesion. Meanwhile, each voxel in the enlarging lesion mask may be labeled with a first value (e.g., “1”) if the voxel is a part of an enlarging lesion and a second value (e.g., “0”) if the voxel is a background voxel that is not a part of an enlarging lesion. As yet another alternative, the output lesion mask may include a new and an enlarging lesion mask, where voxels corresponding to new and enlarging lesions may be labeled with a first value (e.g., “1”) and the background voxels are labeled with a second value (e.g., “0”).

FIG. 4C depicts a flowchart illustrating an example of a process 470 for the post processing of a lesion mask generated by a machine learning model trained to detect new and enlarging lesions (e.g., T2 lesions and/or the like). For example, in some cases, the machine learning controller 110 may perform the process 470 (or a portion thereof) in order to determine whether the lesion mask generated by the first machine learning model 120, which identifies one or more new and/or enlarging lesions in the multitemporal image input 202, includes any false positives (e.g., voxels incorrectly labeled as being a part of a new lesion or an enlarging lesion). Moreover, in some cases, the process 470 may implement operation 406 of the process 400 shown in FIG. 4A.

At 472, the machine learning controller 120 may determine, based on a first reference lesion mask from a first timepoint or a second reference lesion mask from a second timepoint, if a lesion mask generated by a trained machine learning model includes at least one voxel that is incorrectly identified as being a part of a new lesion or an enlarging lesion. For example, the machine learning controller 110 may determine, based at least on the reference lesion mask 208 (e.g., the first reference lesion mask from the first timepoint and the second reference lesion mask from the second timepoint), that a voxel in the lesion mask identifies as a part of a new lesion is a false positive if the reference lesion mask 208 identifies the same voxel as a part of a lesion at the first timepoint or a part of the background at the second timepoint. In this context, a reference lesion mask may be a cross sectional lesion mask identifying the lesions that are present in an image (e.g., a magnetic resonance imaging (MRI) scan) at any single point in time. A new lesion is a lesion that is present at the second timepoint but not at the first timepoint. Accordingly, the machine learning controller 110 may verify that a voxel correctly identified as a part of a new lesion if the voxel is a part of the background at the first timepoint and a part of a lesion (e.g., a lesion whose dimensions satisfy one or more thresholds) at the second timepoint. Contrastingly, a voxel that the lesion mask identifies as a part of a new lesion may be a false positive if that same voxel is a part of a lesion that is already present at the first timepoint or if that same voxel is part of the background (instead of a lesion) at the second timepoint.

In some cases, the machine learning controller 110 may also verify, based at least on the reference lesion mask 208, whether a voxel in the lesion mask is correctly identified as a part of an enlarging lesion. For example, an enlarging lesion is a lesion that undergoes, between the first timepoint and the second timepoint, an increase in one or more dimensions satisfying one or more thresholds. Accordingly, a false positive in the case of an incorrectly identified enlarging lesion may include a voxel that is a part of a lesion that is present in the reference lesion mask 208 at the first timepoint but not the second timepoint, a voxel that is a part of a lesion that is present in the reference lesion mask 208 at the second timepoint but not the first timepoint, and a voxel that is a part of a lesion whose change in dimensions between the first timepoint and the second timepoint fails to satisfy the one or more thresholds.

At 474, the machine learning controller 110 may determine, based at least on a first image from the first timepoint and/or a second image from the second timepoint, if the lesion mask generated by the trained machine learning model includes at least one voxel that is incorrectly identified as being a part of a new lesion or an enlarging lesion. In some example embodiments, the machine learning controller 110 may also perform post processing based on the images 206 in the multitemporal image input 202. For example, in some cases, the machine learning controller 110 may examine the intensity characteristics of the voxels in the images 206 to determine whether those intensity characteristics are consistent with the new and/or enlarging lesions identified in the lesion mask. The machine learning controller 110 may examine the images 206 instead of or in addition to the reference lesion mask 208 at least because of the likelihood of false positives (e.g., voxels incorrectly identified as part of a lesion or background) in the reference lesion mask 208. Accordingly, in some cases, the machine learning controller 110 may determine the distribution of intensity values in a particular image (e.g., the first image from the first timepoint, the second image from the second timepoint, and/or the like), for example, by generating a histogram and/or the like. In doing so, the machine learning controller 110 may identify one or more voxels whose intensity value are within a threshold range of the intensity values of the background voxels. A false positive in this instance may be a voxel identified by the lesion mask as being a new lesion but whose intensity value in the images 206 is within the threshold range of the intensity of the background voxels. Alternatively and/or additionally, a false positive may be a voxel whose intensity is within the threshold range of the intensity of the background voxels but is identified as being a part of a new portion of an existing lesion, thus leading to the identification of an enlarging lesion in the lesion mask.

In some cases, a false positive may also be detected if the change in the intensity values of corresponding voxels in the first image from the first timepoint and the second image from the second timepoint fails to satisfy one or more thresholds. For example, a voxel identified by the lesion mask as being a part of a new lesion may be a false positive if a difference in a first intensity value of the voxel in the first image from the first timepoint and a second intensity value of the same voxel in the second image from the second timepoint fails to satisfy one or more thresholds. Meanwhile, a voxel identified by the lesion mask as being a part of an enlarging lesion may be a false positive if the voxel from a new, enlarged portion of an existing lesion from the first timepoint but the difference in the first intensity value of the voxel in the first image from the first timepoint and the second intensity value of the same voxel in the second image from the second timepoint fails to satisfy one or more thresholds.

### Experiments

In an example, three models were trained with different multitemporal image inputs (e.g., the multitemporal image input 202). The models were trained on images and annotations. For example, the multitemporal image input used to train a first model NewEn-T2lesₙₒ included patches from T₂-weighted magnetic resonance imaging images and fluid attenuated inversion recovery magnetic resonance image sequences. The multitemporal image input used to train a second model NewEn-T2les_{GT} included patches from T₂-weighted magnetic resonance imaging images, fluid attenuated inversion recovery magnetic resonance image sequence, and ground truth T₂ lesion masks. The multitemporal image input used to train a third model NewEn-T2lesᵤₙₑₜ included patches from T₂-weighted magnetic resonance imaging images, fluid attenuated inversion recovery magnetic resonance image sequences, and T₂ lesion masks predicted by another machine learning model (e.g., the second machine learning model 320) trained on cross-sectional magnetic resonance imaging images and annotations. Consistent with implementations of the current subject matter, the first machine learning model 120 may include the first model NewEn-T2lesₙₒ, the second model NewEn-T2les_{GT}, and/or the third model NewEn-T2lesᵤₙₑₜ.

The three models were trained with three-fold cross validation stratified by total T₂ lesion volume. The input patches of the multitemporal image input were created using a sliding window and the patches that contained any T₂ lesion were retained for training and validation. The input images of the multitemporal image input were rescaled to the same intensity range and z-scored. To reduce overfitting during training, a majority of the patches were augmented on the fly during patch generation using affine and elastic transformations. The models were trained with a combination of Tversky- and weighted binary cross-entropy loss.

The multitemporal image inputs were rescaled and normalized the same as during training and model predictions were obtained on the entire three-dimensional volume without splitting into patches as the three models were fully convolutional. Mean dice coefficient (DC), positive predictive value (PPV or precision), true positive rate (TPR or sensitivity), absolute volume difference (AVD) and Pearson's correlation coefficient (rvol) of the predicted and ground truth volumes were used as metrics to evaluate the segmentation performance of the three models. Individual lesions were identified as connected components (e.g., with an 18-connectivity) in the ground truth and predicted lesion masks, predictions smaller than three voxels were excluded and a minimum overlap of 10% was used for detection. Lesion false positive rate (LFPR), lesion PPV (LPPV), lesion TPR (LTPR) and Pearson's correlation coefficient (rcount) of lesion counts predicted by the three models and those in the ground truth masks were used as metrics for evaluating detection performance. Detection performance was also estimated in subgroups with varying lesion sizes: small lesions (3-10 voxels), medium-size lesions (11-50) and large lesions (51-100 voxels, >100 voxels).

A rule-based approach was used for identifying new and enlarging T₂ lesions from serial ground truth T₂ lesion masks to approximate the percent reduction in the mean number of new and enlarging T₂ lesions. New lesions were defined as T₂ lesions in the follow-up timepoint (e.g., the second timepoint) that does not overlap the T₂ lesion mask at baseline (e.g., the first timepoint) dilated by one voxel. To help avoid false positives, new and enlarging T₂ lesions due to the presence of false negatives in the T₂ lesion masks at timepoint 0 (e.g., the first timepoint), only T₂ lesions where the median intensity increased by at least 20% between the two timepoints were retained. Enlarging lesions were defined as lesions that increased in volume by a minimum of 3-fold between baseline (e.g., the first timepoint) and follow-up timepoints (e.g., the second timepoint). Both new and enlarging T₂ lesions had a minimum size of 3 voxels. The same rules were then applied to T₂ lesion masks predicted by the T₂ lesion segmentation model (e.g., the second machine learning model 320) to identify new and enlarging T₂ lesions.

The segmentation performance of the three models is summarized in Table 2 below:

TABLE 2

| Test | | | | | |
|---|---|---|---|---|---|
| dataset | Models | DC | PPV | TPR | rᵥₒₗ |
| Opera II | NewEn- | 0.55 ± 0.216 | 0.486 ± 0.221 | 0.744 ± 0.271 | 0.915 |
| | T2lesₙₒ | | | | |
| | NewEn- | 0.581 ± 0.226 | 0.568 ± 0.223 | 0.691 ± 0.291 | 0.918 |
| | T2lesᵤₙₑₜ | | | | |
| | NewEn- | 0.691 ± 0.203 | 0.597 ± 0.201 | 0.903 ± 0.234 | 0.988 |
| | T2les_{GT} | | | | |

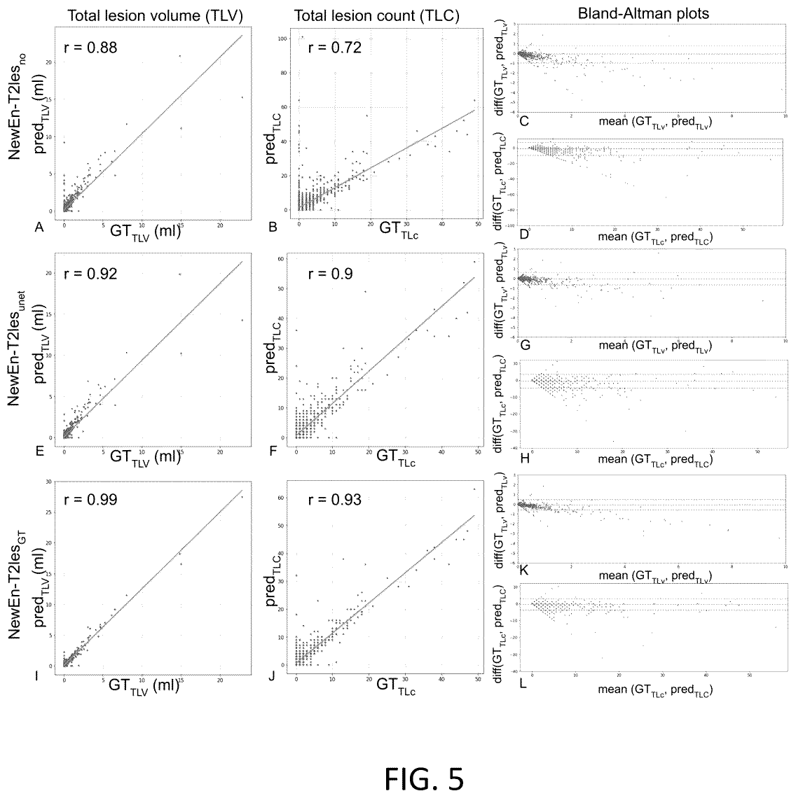

As shown in Table 2, the inclusion of T₂ lesion masks as part of the multitemporal image input to the three improved the mean DC and PPV when using cross-sectional predicted and ground truth T₂ lesion masks. The good correlation between ground truth and predicted total lesion volumes for all available successive timepoints is evident in the correlation plots shown in FIG. 5. As shown in FIG. 5, the Bland-Altman plots depict the mean and difference between the ground truth and model predicted volumes. The majority of the model predicted total lesion volumes fell within the ±95% confidence limits.

The detection performance of the three models is summarized in Table 3 below:

TABLE 3

| Test | | | | | |
|---|---|---|---|---|---|
| dataset | Models | LFPR | LPPV | LTPR | r_{count} |
| Opera II | NewEn- | 0.365 ± 0.30 | 0.641 ± 0.297 | 0.894 ± 0.25 | 0.778 |
| | T2lesₙₒ | | | | |
| | NewEn- | 0.293 ± 0.287 | 0.708 ± 0.291 | 0.874 ± 0.276 | 0.91 |
| | T2lesᵤₙₑₜ | | | | |
| | NewEn- | 0.195 ± 0.257 | 0.798 ± 0.262 | 0.933 ± 0.219 | 0.947 |
| | T2les_{GT} | | | | |

As shown in Table 3, inclusion of ground truth T₂ lesion masks as part of the multitemporal image input to the third model reduced the LFPR by 7-17% and improved LTPR by approximately 4%. The correlation between total lesion counts from the model predicted and ground truth masks also improved with the inclusion of ground truth T₂ lesion masks and the corresponding Bland-Altman plots in FIG. 5.

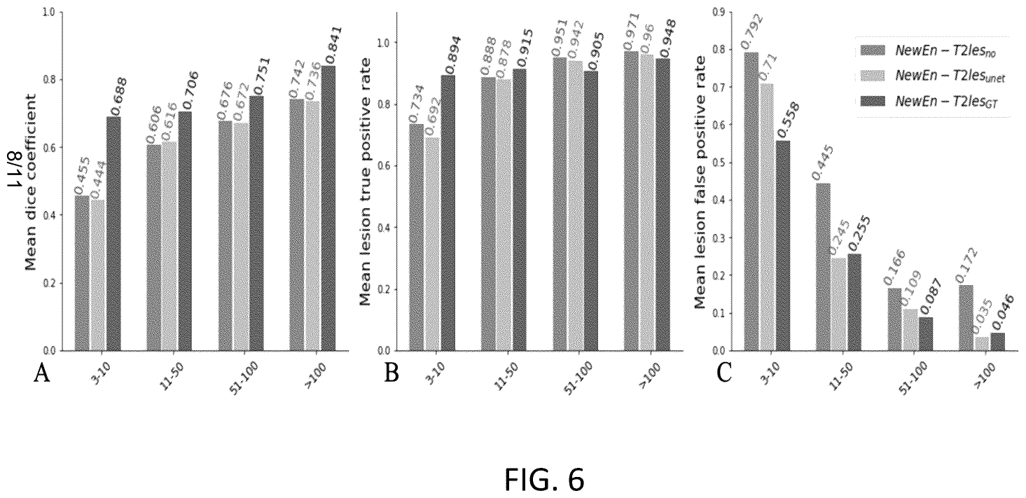

The performance of the three tested models for small T₂ lesion sizes (3-10 voxels), mid T₂ lesion sizes (11-50 voxels) and large T₂ lesion sizes (greater than 50 voxels) is depicted in FIG. 6. As shown in FIG. 6, 32% of T₂ lesions were considered small lesions, 50% of T₂ lesions were considered mid-size lesions, and 18% of T₂ lesions were considered large lesions. The mean LTPR was similar across the three models and exhibited an 8-23% reduction for small lesion sizes and a 12-13% reduction for large lesion sizes in models that used T₂ lesion masks as a part of the multitemporal image input. The third model (NewEn-T2les_{GT}) had the best mean DC while the other two models had similar mean DC.

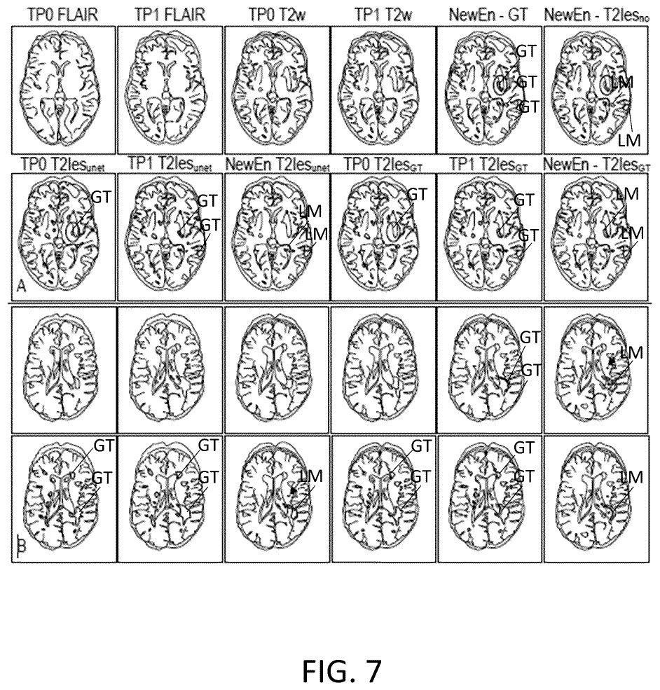

FIG. 7 illustrates representative new and enlarging T₂ lesion segmentations of the three models. For example, FIG. 7 shows the magnetic resonance imaging images and overlays of ground truth (with lesion voxels labeled “GT” in FIG. 7) and model-predicted masks (with lesion voxels labeled “LM” in FIG. 7), such as patient lesion masks generated by the trained machine learning model 120. Images in the top row of FIG. 7 are the fluid attenuated inversion recovery and T₂-weighted slices of a patient at 24 weeks (TP₀—the first timepoint) and 48 weeks (TP1—the second timepoint), the ground truth new and enlarging T₂ lesions at 48 weeks defined with respect to at 24 weeks, and the new and enlarging T₂ lesions (shown as a mask) predicted by the model NewEn-T2lesₙₒ. The second row illustrates new and enlarging T₂ lesions predicted by the NewEn-T2lesᵤₙₑₜ and NewEn-T2les_{GT} models, the T₂ lesion masks predicted (with lesion voxels labeled “GT” in FIG. 7) by previously trained T₂ lesion segmentation models (e.g., by the second machine learning model 320) used as an additional input in NewEn-T2lesᵤₙₑₜ, and the ground truth T₂ lesion masks (with lesion voxels labeled “GT” in FIG. 7) used as the third set of inputs in NewEn-T2les_{GT}. The ground truth total lesion volume was 3.89 ml (1359 voxels) and had a total lesion count of 36. The dice coefficients of the first, second, and third models were 0.74, 0.76, and 0.81, respectively, and the first, second, and third models detected 33, 32, and 36 lesions, respectively with 6, 5, and 2 false positive lesions, respectively. Images in the third and fourth rows of FIG. 7 are of a patient at 48 weeks (TP₀—the first timepoint) and 96 weeks (TP1—the second timepoint) with a total lesion volume of 4.44 milliliters (1551 voxels) and a total lesion count of 14. The dice coefficients of the first, second, and third models were 0.69, 0.7, and 0.84, respectively and the first, second, and third models detected 13, 10, and 14 T₂ lesions, respectively, with 3, 2, 2 false positive T₂ lesions respectively.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Item 1: A system, comprising: at least one data processor; and at least one memory storing instructions, which when executed by the at least one data processor, result in operations comprising: training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least: generating a first representation of the multitemporal image input from the first timepoint to the second timepoint; generating a second representation of the multitemporal image input from the second timepoint to the first timepoint; generating a third representation of the multitemporal image input including a concatenation of the first representation and the second representation; and generating a lesion mask identifying the one or more new lesions and/or enlarging lesions, the lesion mask corresponding to a decoding of the third representation of the multitemporal image input; and applying the trained machine learning model to generate, for one or more images of a patient, a patient lesion mask identifying at least one of a new lesion and an enlarging lesion present in the one or more images.

Item 2: The system of Item 1, wherein encoding blocks of the first machine learning model comprise a first unidirectional convolutional gated recurrent unit (cGRU) configured to generate the first representation of the multitemporal image input and a second unidirectional convolutional gated recurrent unit configured to generate the second representation of the multitemporal image input.

Item 3: The system of any of Items 1 to 2, wherein the first machine learning model comprises one or more convolutional layers configured to decode the third representation of the multitemporal image input.

Item 4: The system of any of Items 1 to 3, wherein the generating the first representation of the multitemporal image input includes extracting a first set of temporal features present in the multitemporal image input from the first timepoint to the second timepoint, and wherein the generating the second representation of the multitemporal image input includes extracting a second set of temporal features present in the multitemporal image input from the second timepoint to the first timepoint.

Item 5: The system of any of Items 1 to 4, wherein the multitemporal image input comprises a 6-dimensional tensor including a batch size, a timepoint, channels, and spatial coordinates.

Item 6: The system of any of Items 1 to 5, wherein the third representation of the multitemporal image input comprises a 5-dimensional tensor including a batch size, channels, and spatial coordinates.

Item 7: The system of any of Items 1 to 6, wherein the multitemporal image input includes a reference lesion mask identifying one or more existing lesions present in the first image and/or the second image, and wherein the reference lesion mask is configured to provide attention to the one or more existing lesions.

Item 8: The system of Item 7, wherein the reference lesion mask is generated by applying a second machine learning model.

Item 9: The system of Item 8, wherein the second machine learning model is pre-trained based on a cross-sectional magnetic resonance imaging sequence and an annotation of the cross-sectional magnetic resonance imaging sequence.

Item 10: The system of Item 9, wherein the first machine learning model and the second machine learning model are chained such that an output of the second machine learning model is provided as an input to the first machine learning model.

Item 11: The system of Item 10, wherein the first machine learning model and the second machine learning model are jointly trained including by backpropagating a loss associated with incorrectly identifying the one or more new lesions and/or enlarging lesions through the first machine learning model and the second machine learning model and a loss associated with T₂ lesion masks through the second machine learning model only.

Item 12: The system of any of Items 1 to 11, wherein the first image and the second image include T₂-weighted images and/or fluid attenuated inversion recovery images.

Item 13: The system of any of Items 1 to 12, wherein the first machine leaning model is trained based one or more lesion masks with ground truth annotations.

Item 14: The system of any of Items 1 to 13, wherein each of the first representation and the second representation is an encoding of the multitemporal image input.

Item 15: The system of any of Items 1 to 14, wherein the operations further comprise: determining if a new lesion and/or an enlarging lesion identified in the patient lesion mask is a false positive; and rejecting the patient lesion mask for one or more downstream clinical tasks in response to determining that the new lesion and/or the enlarging lesion identified in the patient lesion mask is a false positive.

Item 16: The system of Item 15, wherein the new lesion and/or the enlarging lesion are determined to be a false positive based at least on a first intensity value of one or more constituent voxels in a first patient image from the first timepoint, a second intensity value of one or more constituent voxels in a second patient image from the second timepoint, and a third intensity value of one or more background voxels in the first patient image and/or the second patient image.

Item 17: The system of any of Items 15 to 16, wherein the new lesion is determined to be a false positive based at least on one or more voxels identified by the patient lesion mask as corresponding to the new lesion being (i) identified as corresponding to an existing lesion in a first reference lesion mask of the patient from a first timepoint, or (ii) identified as background voxels in a second reference lesion mask of the patient from a second timepoint.

Item 18: The system of any of Items 15 to 17, wherein the enlarging lesion is determined to be a false positive based at least on (i) one or more voxels identified by the patient lesion mask as corresponding to the enlarging lesion being absent in a first reference lesion mask of the patient from a first timepoint or a second reference lesion mask of the patient from a second timepoint, and (ii) the one or more voxels being a part of an existing lesion whose change in dimensions between the first timepoint and the second timepoint fails to satisfy one or more thresholds.

Item 19: The system of any of Items 15 to 18, wherein the operations further comprise: determining that a threshold quantity of patient lesions masks generated by the trained machine learning model based on patient images include a false positive identification of a new lesion or an enlarging lesion; and retraining the trained machine learning model upon determining that the threshold quantity of patient lesion mask generated by the trained machine learning model includes a false positive identification of a new lesion or an enlarging lesion.

Item 20: The system of any of Items 1 to 19, wherein each voxel in the patient lesion mask is labeled a first value to indicate the voxel as being a part of a new lesion, a second value to indicate the voxel as being a part of an enlarging lesion, or a third value to indicate the voxel as being a background voxel.

Item 21: A computer-implemented method, comprising: training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least: generating a first representation of the multitemporal image input from the first timepoint to the second timepoint; generating a second representation of the multitemporal image input from the second timepoint to the first timepoint; generating a third representation of the multitemporal image input including a concatenation of the first representation and the second representation; and generating a lesion mask identifying the one or more new lesions and/or enlarging lesions, the lesion mask corresponding to a decoding of the third representation of the multitemporal image input; and applying the trained machine learning model to generate, for one or more images of a patient, a patient lesion mask identifying at least one of a new lesion and an enlarging lesion present in the one or more images.

Item 22: The method of Item 21, wherein encoding blocks of the first machine learning model comprise a first unidirectional convolutional gated recurrent unit (cGRU) configured to generate the first representation of the multitemporal image input and a second unidirectional convolutional gated recurrent unit configured to generate the second representation of the multitemporal image input.

Item 23: The method of any of Items 21 to 22, wherein the first machine learning model comprises one or more convolutional layers configured to decode the third representation of the multitemporal image input.

Item 24: The method of any of Items 21 to 23, wherein the generating the first representation of the multitemporal image input includes extracting a first set of temporal features present in the multitemporal image input from the first timepoint to the second timepoint, and wherein the generating the second representation of the multitemporal image input includes extracting a second set of temporal features present in the multitemporal image input from the second timepoint to the first timepoint.

Item 25: The method of any of Items 21 to 24, wherein the multitemporal image input comprises a 6-dimensional tensor including a batch size, a timepoint, channels, and spatial coordinates.

Item 26: The method of any of Items 21 to 25, wherein the third representation of the multitemporal image input comprises a 5-dimensional tensor including a batch size, channels, and spatial coordinates.

Item 27: The method of any of Items 21 to 26, wherein the multitemporal image input includes a reference lesion mask identifying one or more existing lesions present in the first image and/or the second image, and wherein the reference lesion mask is configured to provide attention to the one or more existing lesions.

Item 28: The method of Item 27, wherein the reference lesion mask is generated by applying a second machine learning model.

Item 29: The method of Item 28, wherein the second machine learning model is pre-trained based on a cross-sectional magnetic resonance imaging sequence and an annotation of the cross-sectional magnetic resonance imaging sequence.

Item 30: The method of Item 29, wherein the first machine learning model and the second machine learning model are chained such that an output of the second machine learning model is provided as an input to the first machine learning model.

Item 31: The method of Item 30, wherein the first machine learning model and the second machine learning model are jointly trained including by backpropagating a loss associated with incorrectly identifying the one or more new lesions and/or enlarging lesions through the first machine learning model and the second machine learning model and a loss associated with T₂ lesion masks through the second machine learning model only.

Item 32: The method of any of Items 21 to 31, wherein the first image and the second image include T₂-weighted images and/or fluid attenuated inversion recovery images.

Item 33: The method of any of Items 21 to 32, wherein the first machine leaning model is trained based one or more lesion masks with ground truth annotations.

Item 34: The method of any of Items 21 to 33, wherein each of the first representation and the second representation is an encoding of the multitemporal image input.

Item 35: The method of any of Items 21 to 34, further comprising: determining if a new lesion and/or an enlarging lesion identified in the patient lesion mask is a false positive; and rejecting the patient lesion mask for one or more downstream clinical tasks in response to determining that the new lesion and/or the enlarging lesion identified in the patient lesion mask is a false positive.

Item 36: The method of Item 35, wherein the new lesion and/or the enlarging lesion are determined to be a false positive based at least on a first intensity value of one or more constituent voxels in a first patient image from the first timepoint, a second intensity value of one or more constituent voxels in a second patient image from the second timepoint, and a third intensity value of one or more background voxels in the first patient image and/or the second patient image.

Item 37: The method of any of Items 35 to 36, wherein the new lesion is determined to be a false positive based at least on one or more voxels identified by the patient lesion mask as corresponding to the new lesion being (i) identified as corresponding to an existing lesion in a first reference lesion mask of the patient from a first timepoint, or (ii) identified as background voxels in a second reference lesion mask of the patient from a second timepoint.

Item 38: The method of any of Items 35 to 37, wherein the enlarging lesion is determined to be a false positive based at least on (i) one or more voxels identified by the patient lesion mask as corresponding to the enlarging lesion being absent in a first reference lesion mask of the patient from a first timepoint or a second reference lesion mask of the patient from a second timepoint, and (ii) the one or more voxels being a part of an existing lesion whose change in dimensions between the first timepoint and the second timepoint fails to satisfy one or more thresholds.

Item 39: The method of any of Items 35 to 38, further comprising: determining that a threshold quantity of patient lesions masks generated by the trained machine learning model based on patient images include a false positive identification of a new lesion or an enlarging lesion; and retraining the trained machine learning model upon determining that the threshold quantity of patient lesion mask generated by the trained machine learning model includes a false positive identification of a new lesion or an enlarging lesion.

Item 40: The method of any of Items 21 to 39, wherein each voxel in the patient lesion mask is labeled a first value to indicate the voxel as being a part of a new lesion, a second value to indicate the voxel as being a part of an enlarging lesion, or a third value to indicate the voxel as being a background voxel.

Item 41: A non-transitory computer readable medium storing instructions, which when executed by at least one data processor, result in operations comprising: training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least: generating a first representation of the multitemporal image input from the first timepoint to the second timepoint; generating a second representation of the multitemporal image input from the second timepoint to the first timepoint; generating a third representation of the multitemporal image input including a concatenation of the first representation and the second representation; and generating a lesion mask identifying the one or more new lesions and/or enlarging lesions, the lesion mask corresponding to a decoding of the third representation of the multitemporal image input; and applying the trained machine learning model to generate, for one or more images of a patient, a patient lesion mask identifying at least one of a new lesion and an enlarging lesion present in the one or more images.

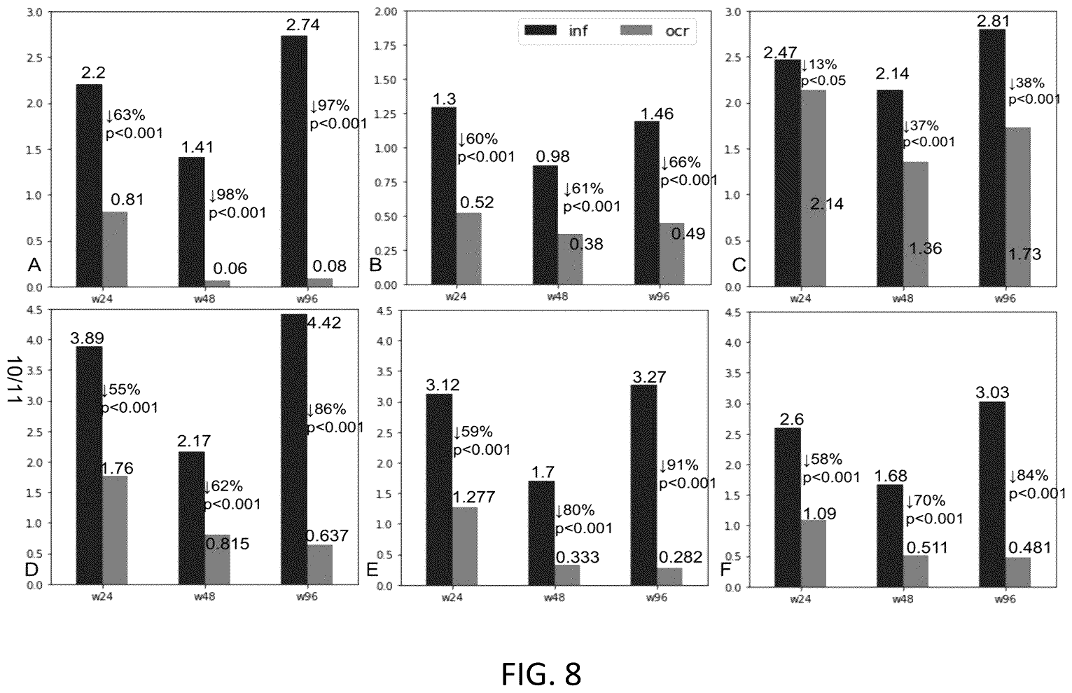

FIG. 8 shows a comparison between the three tested models and a manual analysis of new and enlarging T₂ lesions. For example, graph (A) shows a mean number of new and enlarging T₂ lesions using a manual analysis, graph (B) shows a mean number of new and enlarging T₂ lesions using a rule-based approach applied to ground truth T₂ lesion masks, graph (C) shows a mean number of new and enlarging T₂ lesions using a rule-based approach applied to T₂ lesion masks predicted by a previously trained U-Net, graph (D) shows a mean number of new and enlarging T₂ lesions using predictions of the first model NewEn-T2lesₙₒ, graph E shows a mean number of new and enlarging T₂ lesions using predictions of the second model NewEn-T2lesᵤₙₑₜ, and graph (F) shows a mean number of new and enlarging T₂ lesions using predictions of the third model NewEn-T2les_{GT}. Accordingly, the three models (e.g., the first machine learning model 120) may provide fully automated spatiotemporal U-Nets for robust detection and segmentation of new and enlarging T₂ lesions.

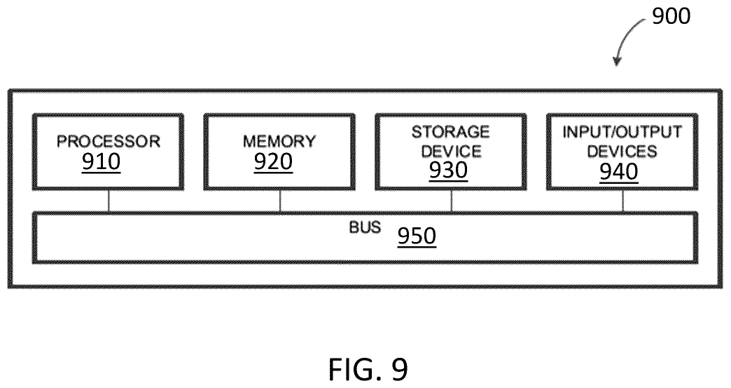

FIG. 9 depicts a block diagram illustrating a computing system 900 consistent with implementations of the current subject matter. Referring to FIGS. 1-9, the computing system 900 can be used to implement the machine learning controller 110, the first machine learning model 120, and/or any components therein.

As shown in FIG. 9, the computing system 900 can include a processor 910, a memory 920, a storage device 930, and input/output devices 940. The processor 910, the memory 920, the storage device 930, and the input/output devices 940 can be interconnected via a system bus 950. The computing system 900 may additionally or alternatively include a graphic processing unit (GPU), such as for image processing, and/or an associated memory for the GPU. The GPU and/or the associated memory for the GPU may be interconnected via the system bus 950 with the processor 910, the memory 920, the storage device 930, and the input/output devices 940. The memory associated with the GPU may store one or more images described herein, and the GPU may process one or more of the images described herein. The GPU may be coupled to and/or form a part of the processor 910. The processor 910 is capable of processing instructions for execution within the computing system 900. Such executed instructions can implement one or more components of, for example, the machine learning controller 110 and the first machine learning model 120. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940.

The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
a processor; and
a memory storing instructions which, when executed by the processor, result in operations comprising:
training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least:
generating a first representation of the multitemporal image input from the first timepoint to the second timepoint;
generating a second representation of the multitemporal image input from the second timepoint to the first timepoint;
generating a third representation of the multitemporal image input including a concatenation of the first representation and the second representation; and
generating a lesion mask identifying the one or more new lesions and/or enlarging lesions, the lesion mask corresponding to a decoding of the third representation of the multitemporal image input; and
applying the trained machine learning model to generate, for one or more images of a patient, a patient lesion mask identifying at least one of a new lesion and an enlarging lesion present in the one or more images.

2. The system of claim 1, wherein encoding blocks of the first machine learning model comprise a first unidirectional convolutional gated recurrent unit (cGRU) configured to generate the first representation of the multitemporal image input and a second unidirectional convolutional gated recurrent unit configured to generate the second representation of the multitemporal image input.

3. The system of claim 1, wherein the first machine learning model comprises one or more convolutional layers configured to decode the third representation of the multitemporal image input.

4. The system of claim 1, wherein the generating the first representation of the multitemporal image input includes extracting a first set of temporal features present in the multitemporal image input from the first timepoint to the second timepoint, and wherein the generating the second representation of the multitemporal image input includes extracting a second set of temporal features present in the multitemporal image input from the second timepoint to the first timepoint.

5. The system of claim 1, wherein the multitemporal image input comprises a 6-dimensional tensor including a batch size, a timepoint, channels, and spatial coordinates.

6. The system of claim 1, wherein the third representation of the multitemporal image input comprises a 5-dimensional tensor including a batch size, channels, and spatial coordinates.

7. The system of claim 1, wherein the multitemporal image input includes a reference lesion mask identifying one or more existing lesions present in the first image and/or the second image, and wherein the reference lesion mask is configured to provide attention to the one or more existing lesions.

8. The system of claim 7, wherein the reference lesion mask is generated by applying a second machine learning model.

9. The system of claim 8, wherein the second machine learning model is pre-trained based on a cross-sectional magnetic resonance imaging sequence and an annotation of the cross-sectional magnetic resonance imaging sequence.

10. The system of claim 9, wherein the first machine learning model and the second machine learning model are chained such that an output of the second machine learning model is provided as an input to the first machine learning model.

11. The system of claim 10, wherein the first machine learning model and the second machine learning model are jointly trained including by backpropagating a loss associated with incorrectly identifying the one or more new lesions and/or enlarging lesions through the first machine learning model and the second machine learning model and a loss associated with T₂ lesion masks through the second machine learning model only.

12. The system of claim 1, wherein the first image and the second image include T₂-weighted images and/or fluid attenuated inversion recovery images.

13. The system of claim 1, wherein the first machine leaning model is trained based one or more lesion masks with ground truth annotations.

14. The system of claim 1, wherein each of the first representation and the second representation is an encoding of the multitemporal image input.

15. The system of claim 1, wherein the operations further comprise:
determining if a new lesion and/or an enlarging lesion identified in the patient lesion mask is a false positive; and
rejecting the patient lesion mask for one or more downstream clinical tasks in response to determining that the new lesion and/or the enlarging lesion identified in the patient lesion mask is a false positive.

16. The system of claim 15, wherein the new lesion and/or the enlarging lesion are determined to be a false positive based at least on a first intensity value of one or more constituent voxels in a first patient image from the first timepoint, a second intensity value of one or more constituent voxels in a second patient image from the second timepoint, and a third intensity value of one or more background voxels in the first patient image and/or the second patient image.

17. The system of claim 15, wherein the new lesion is determined to be a false positive based at least on one or more voxels identified by the patient lesion mask as corresponding to the new lesion being (i) identified as corresponding to an existing lesion in a first reference lesion mask of the patient from a first timepoint, or (ii) identified as background voxels in a second reference lesion mask of the patient from a second timepoint.

18. The system of claim 15, wherein the enlarging lesion is determined to be a false positive based at least on (i) one or more voxels identified by the patient lesion mask as corresponding to the enlarging lesion being absent in a first reference lesion mask of the patient from a first timepoint or a second reference lesion mask of the patient from a second timepoint, and (ii) the one or more voxels being a part of an existing lesion whose change in dimensions between the first timepoint and the second timepoint fails to satisfy one or more thresholds.

19. The system of claim 15, wherein the operations further comprise:
determining that a threshold quantity of patient lesions masks generated by the trained machine learning model based on patient images include a false positive identification of a new lesion or an enlarging lesion; and
retraining the trained machine learning model upon determining that the threshold quantity of patient lesion mask generated by the trained machine learning model includes a false positive identification of a new lesion or an enlarging lesion.

20. The system of claim 1, wherein each voxel in the patient lesion mask is labeled a first value to indicate the voxel as being a part of a new lesion, a second value to indicate the voxel as being a part of an enlarging lesion, or a third value to indicate the voxel as being a background voxel.

21. A computer-implemented method, comprising:
training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least:
generating a first representation of the multitemporal image input from the first timepoint to the second timepoint;
generating a second representation of the multitemporal image input from the second timepoint to the first timepoint;
generating a third representation of the multitemporal image input including a concatenation of the first representation and the second representation; and
generating a lesion mask identifying the one or more new lesions and/or enlarging lesions, the lesion mask corresponding to a decoding of the third representation of the multitemporal image input; and
applying the trained machine learning model to generate, for one or more images of a patient, a patient lesion mask identifying at least one of a new lesion and an enlarging lesion present in the one or more images.

22. A non-transitory computer readable medium storing instructions, which when executed by at least one processor, result in operations comprising:
training a first machine learning model to identify one or more new lesions and/or enlarging lesions that developed within a multitemporal image input between a first timepoint and a second timepoint, the multitemporal image input including a first image acquired at the first timepoint and a second image acquired at the second timepoint, the first machine learning model being trained to identify the one or more new lesions and/or enlarging lesions by at least:
generating a first representation of the multitemporal image input from the first timepoint to the second timepoint;
generating a second representation of the multitemporal image input from the second timepoint to the first timepoint;
generating a third representation of the multitemporal image input including a concatenation of the first representation and the second representation; and
generating a lesion mask identifying the one or more new lesions and/or enlarging lesions, the lesion mask corresponding to a decoding of the third representation of the multitemporal image input; and
applying the trained machine learning model to generate, for one or more images of a patient, a patient lesion mask identifying at least one of a new lesion and an enlarging lesion present in the one or more images.
